(19) United States
(12) Patent Application Publication
(10) Pub. No.: US 2004/0128196 A1
(43) Pub. Date: Jul. 1, 2004

(54) One-to-one business support system and program for implementing the function of the system

(76) Inventor: Masatsugu Shibuno, Tokyo (JP)

Correspondence Address: MORRISON & FOERSTER LLP, 1650 TYSONS BOULEVARD, SUITE 300, MCLEAN, VA, 22102, US

(21) Appl. No.: 10/665,741

(22) Filed: Sep. 22, 2003

(30) Foreign Application Priority Data
Sep. 19, 2002 (JP) 2002-273197
Nov. 22, 2002 (JP) 2002-338941
Sep. 12, 2003 (JP) 2003-320815

(51) Int. Cl. G06F 17/60

(52) U.S. Cl. 705/14

(57) ABSTRACT

A POS data storage stores customer information including customer attribute information and purchase information transmitted from a shop. An ASP service sets an application stored in an AP server of an ASP center to be operatable by a main office terminal and a shop terminal. The main office terminal analyzes customer information stored by the application, narrows down a target customer based on the analytical result, generates an action plan on a one-to-one basis for each target customer, issues a relation tool, and performs evaluation and analysis on a one-to-one action.

This application is based on Japanese Patent Applications No. 2002-273197 filed on Sep. 19, 2002, No. 2002-338941 filed on Nov. 22, 2002 and No. 2003-320815 filed on Sep. 12, 2003, each including specification, claims, drawings and summary. The disclosures of the above Japanese Patent Applications are incorporated herein by reference in its entirety.

### BACKGROUND OF THE INVENTION

1. Field of the Invention

The present invention relates to a system capable of providing a one-to-one business that performs analysis using customer information and purchase information on each customer, identifies each customer using the analytical result to plan an appropriate service for each customer, and selects and issues a tool for executing service.

2. Description of the Related Art

One-to-one marketing is one marketing method that aims to capture customer share, not market share. For example, there is a method that aims to sale more products and services to customers by building up loyalty to products and services over the lifetime of each customer using interactive media. The one-to-one marketing adopts a method that changes treatment for each customer to meet a variety of needs in order to increase the customer share.

In recent years, CRM (Customer Relationship Management), which is based on the aforementioned one-to-one business, is largely expected to be in practical use. CRM aims to decide an appropriate marketing method for each individual customer to maintain customers by unifying management of data on customer information to segment the customers precisely. Unlike the conventional customer management, CRM is characterized in providing a mechanism that performs analysis in such a manner that the customers and products are associated with each other and executes some action as a strategy for increasing sales to the customers based on the analytical result.

However, it is a rare case that increases sales by introducing the existing CRM. The reason can be explained as follows. Specifically, since CRM has mainly a compiling and analyzing system function, there is an idea that the strategy for increasing sales is left to the marketer of the company that introduced CRM. Moreover, in many cases, the compiling and analyzing method aims to increase efficiency as in, for example, RFM (Recency, Frequency, Monetary) analysis and this is not one that decides an effective action by analyzing customers' purchase action and action psychology based on the customer relationship. Namely, the customer relationship is the key to the increase in sales. However, in the conventional case, no matter how much analysis is done, the result is not related to the customer and the customer does not initiate any kind of action. Though salespersons of goods and services hold customer data, they have a problem that they know neither a next way to increase sales nor an appropriate action to be taken.

### SUMMARY OF THE INVENTION

The present invention has been made with consideration given to the aforementioned circumstances, and an object of the present invention is to provide a one-to-one business execution system, and program and storage medium that implement the function of the system capable of effectively and rationally executing one-to-one business that performs analysis using customer information and purchase information on each customer, identifies each customer using the analytical result to plan an appropriate service for each customer, and selects and issues a tool for executing service, making it possible to contribute to company's sales activities and improve an increase in sales.

In order to attain the above object, a one-to-one business support system according to a first aspect of the present invention includes a storage device that stores customer attribute information indicating an attribute of a customer and purchase information indicating a commodity purchased by the customer. The one-to-one business support system may further include a client computer that executes an application program to perform a first function of narrowing down a customer who satisfies a predetermined condition based on the customer information stored in the storage device, a second function of deciding a plan of an action that is performed to the customer narrowed down for each customer, a third function of issuing a relation tool for executing the decided plan, and/or a fourth function of performing an evaluation of the action according to a predetermined criterion. The one-to-one business support system may further include a server that provides the application program to the client computer.

The application program provided by the server may include a program that causes the client computer to execute a fifth function of creating a script that defines the contents of the relation tool in a personalized form for each customer, and a sixth function of issuing the relation tool by instructing the server to output the relation tool having the contents according to the script. The server may include an output device that outputs the relation tool according to the instruction of the client computer.

The server may include a printer that prints the relation tool having the personalized contents for each customer according to an instruction of printing supplied from the client computer.

The client computer may include a main office terminal and a shop terminal. The main office terminal may include an output device that presents at least a part of information used in executing the first to fourth functions to an operator in a recognizable form. The shop terminal may include an output device that presents at least a part of information used in executing the fifth and sixth functions to an operator in a recognizable form.

The output device of the shop terminal may obtain and/or store customer attribute information of a customer, information indicating a rank when the customer is ranked on a predetermined criterion, information indicating a commodity purchased by the customer in the past and information indicating a history of a relation with the customer, and output any one of these information items that confirm to a condition designated by the operator.

The action may include any one or more of an action of an event system that encourages the customer to come to the shop to improve sales promotion, an action of a calendar system that deepens the relationship with the customer to make the customer a regular customer to improve customer loyalization and an action of a shop service system that deepens the relationship with the customer at the shop to improve a sales rate or suggest coordinates.

The action of the event system may include an action that issues a relation tool that transmits a message to the customer on a one-to-one basis, thereby sending a guide for a sales promotion to the customer.

The action of the calendar system may include an action that issues a relation tool according to a calendar preset for each event.

The action of the shop service system may include an action that presents the contents of a personalized script to a person to be served.

The client computer may capture language information indicating words uttered by the customer and present the language information to an operator in a predetermined form that the operator can recognize.

The relation tool may include at least any one of DM (Direct Mail), facsimile, e-mail, and telephone.

The application program provided by the server may include a program that causes the client computer to perform a function of specifying a frequency of which the customer conducts a business transaction at the shop based on the customer attribute information to predict a day when the customer comes to the shop based on the frequency, and a function of detecting an arrival of a predetermined time decided based on the predicted day to perform an output of a message that encourages execution of the action and/or an issue of an relation tool relating to the action.

The application program provided by the server may include a program that causes the client computer to perform a function of obtaining purchase information at multiple points in time in connection with persons, who are customers at one or more of the multiple points in time, to classify the respective customers at the multiple points in time into any of multiple ranks according to a predetermined criterion based on these purchase information and a function of specifying a variation in a customer rank, the number of newly enrolled customers and/or the number of withdrawn customers based on a result of the classification to output information indicating a specified result.

The application program provided by the server may include a program that causes the client computer to perform a function of extracting a customer according to a predetermined condition based on the customer attribute information and/or purchase information and a function of generating data indicating at least any parameter of the number of extracted customers, a frequency of which the corresponding customer purchases a commodity, a type of a commodity purchased by the corresponding customer, a sales amount per one corresponding customer, the number of purchased commodities per one corresponding customer and a unit price of the commodity purchased by the corresponding customer and data indicating a time transition of the parameter value based on the customer attribute information and/or purchase information.

The server may provide the application program by executing an ASP (Application Service Provider) service.

The one-to-one business support system may further include a card reader that reads customer attribute information and/or purchase information from a magnetic card or an IC (Integrated Circuit) card to obtain the customer attribute information and/or purchase information or a POS (Point OF Sales) register that obtains customer attribute information and/or purchase information according to an operation from an operator.

The card reader and the POS register may be connected to the storage device via a communication line, and the obtained customer attribute information and/or purchase information may be supplied to the storage device and stored therein.

The server may include a web server and the web server may provide data to the client computer that functions as a client machine via a network according to a communication procedure where security is ensured.

The one-to-one business support system may further include a database server connected to the storage device via a communication line where security is ensured. The database server and the application server may be connected to each other via a firewall to form a security capsule zone.

Moreover, a computer data signal embedded in a carrier wave according to a second aspect of the present invention indicates a program for causing a computer to function as a storage device that stores customer attribute information indicating an attribute of a customer and purchase information indicating a commodity purchased by the customer, a client computer that executes an application program to perform a first function of narrowing down a customer who satisfies a predetermined condition based on the customer information stored in the storage device, a second function of deciding a plan of an action that is performed to the customer narrowed down for each customer, a third function of issuing a relation tool for executing the decided plan, and/or a fourth function of performing an evaluation of the action according to a predetermined criterion and a server that provides the application program to the client computer.

Furthermore, a computer-readable storage medium according to a third aspect of the present invention has a program recorded thereon. The program causes a computer to function as a storage device that stores customer attribute information indicating an attribute of a customer and purchase information indicating a commodity purchased by the customer, a client computer that executes an application program to perform a first function of narrowing down a customer who satisfies a predetermined condition based on the customer information stored in the storage device, a second function of deciding a plan of an action that is performed to the customer narrowed down for each customer, a third function of issuing a relation tool for executing the decided plan, and/or a fourth function of performing an evaluation of the action according to a predetermined criterion and a server that provides the application program to the client computer.

According to the present invention, there can be provided a one-to-one business support system, program and storage medium that implement the function of the system capable of effectively and rationally executing one-to-one business that performs analysis using customer information and purchase information on each customer, identifies each customer using the analytical result to plan an appropriate service for each customer, and selects and issues a tool for executing service, making it possible to contribute to company's sales activities and improve an increase in sales.

### BRIEF DESCRIPTION OF THE DRAWINGS

These objects and other objects and advantages of the present invention will become more apparent upon reading of the following detailed description and the accompanying drawings in which:

FIG. 1 is a view illustrating an example of a system configuration that carries out a one-to-one business support system of the present invention;

FIG. 2 is a view illustrating a business scheme that is executed by the present invention;

FIG. 3 is a view illustrating a workflow of a system carried out by the above business scheme;

FIG. 4 is a view illustrating a workflow of a management carried out by the above business scheme;

FIG. 5 is a view schematically illustrating a process including generation of an action plan based on a scenario and an issue of a tool according to the plan;

FIG. 6 is a view illustrating a concept that splits a purchase process into a stage structure at the time of setting a scenario for fixing a strategic target;

FIGS. 7A and 7B are views illustrating the stage in FIG. 6;

FIG. 8 is a view illustrating a rule setting screen and shows a rule setting section of a table type;

FIG. 9 is a view illustrating a rule setting screen and shows a rule setting section of an individual type;

FIG. 10 is a view illustrating a rule setting screen and shows a rule display section;

FIG. 11 is a view illustrating one example of a display screen of a contents item section;

FIG. 12 is a view illustrating one example of a display of a contents display section;

FIG. 13 is a view illustrating one example of a customer information screen displayed by a shop terminal;

FIG. 14 is a view illustrating one example of a customer information sub-screen displayed by a shop terminal;

FIG. 15 is a view illustrating one example of a relation history screen displayable by a shop terminal;

FIG. 16 is a view illustrating one example of a sales history screen displayable by a shop terminal;

FIGS. 17A and 17B are views illustrating a customer analyzing method applied to the present invention;

FIGS. 18A and 18B are views illustrating an example of a sales contribution analytical report;

FIGS. 19A and 19B are views illustrating an example of a customer flow analysis;

FIG. 20 is a view illustrating an example in which the number of customers of a single year is divided into segments by a decile analysis;

FIG. 21 is a view illustrating an example in which a maximum amount of money of FIG. 20 is divided into segments in accordance with the previous time;

FIG. 22 is a view showing a table in which the results of FIGS. 20 and 21 are segmented as a customer flow analytical result in connection with the number of customers;

FIG. 23 is a view showing a table in which the results of FIGS. 20 and 21 are segmented as a customer flow analytical result by a percentage of the number of customers;

FIG. 24 is a view illustrating one example of a customer trace analytical screen;

FIG. 25 is a view illustrating another example of a customer flow analysis that is a view in which the number of customers of a single year is divided into segments by a corrected decile analysis;

FIG. 26 is a view illustrating another example of a customer flow analysis that is a view showing an annual change in the segment of corrected decile analysis;

FIG. 27 is a view illustrating another example of a customer flow analysis that is a view in which an amount of sales, the number of customers, and sale proceeds for each group are shown using a Pareto diagram;

FIG. 28 is a view illustrating another example of a customer flow analysis that is a graph in which sales elements (customer sales frequency, one unit price, one customer point) for each group are indexed;

FIG. 29 is a view illustrating another example of a customer flow analysis that is a Pareto diagram showing an annual average sale proceeds per customer for each group;

FIG. 30 is a view illustrating further another example of a customer flow analysis that is a view showing a breakdown of an increase and decrease in connection with the number of customers;

FIG. 31 is a view illustrating further another example of a customer flow analysis that is a view in which a rise/fall in rank is shown by the number of customers;

FIG. 32 is a view illustrating further another example of a customer flow analysis that is a view showing a breakdown of an increase/decrease by a customer ratio;

FIG. 33 is a view illustrating further another example of a customer flow analysis that is a view in which a rise/fall in rank is shown by a customer ratio;

FIG. 34 is a view illustrating further another example of a customer flow analysis that is a view in which withdrawers and new customers are shown by group (rank) in connection with all customers of the shop;

FIG. 35 is a view illustrating further another example of a customer flow analysis that is a view showing a balance between the increase and decrease in the number of customers for each group;

FIG. 36 is a view illustrating further another example of a customer flow analysis that is a view showing a customer flow of a rise and a fall in rank including withdrawals and new enrollments in connection with all customers;

FIG. 37 is a view illustrating one example of comparison between cell contents according to a customer flow analysis that is a view showing an example of customers that moved down in ranks;

FIG. 38 is a view illustrating one example of comparison between cell contents according to a customer flow analysis that is a view showing an example of customers that moved up in ranks;

FIG. 39 is a view illustrating one example of a customer life time analysis that is a view showing a customer age at the time of entry, a customer age at the time of withdrawal, a customer age of a current member, and a customer time;

FIG. 40 is a view illustrating one example of a customer life time analysis that is a view showing a customer time by generation;

FIG. 41 is a view illustrating a change in rank by customer time;

FIGS. 42A and 42B are views illustrating a configuration example of a screen for narrowing down an outbound customer;

FIG. 43 is a view illustrating an example of a DM dispatch selection screen set as an outbound; and

FIG. 44 is a view illustrating an example of a promotion analytical screen.

### DETAILED DESCRIPTION OF THE PREFERRED EMBODIMENT

The following will explain a one-to-one business support system according to an embodiment of the present invention. The one-to-one business support system set forth below provides a function of planning a strategy for increasing sales based on a scenario created in the form that purchase action and psychology in connection with a customer as a partner of a relationship to be established are considered as a time axis. Regarding the relationship marketing activities for a sales staff concerned with a specific business type/business category and a shop manager/salesperson, this one-to-one business support system is used to practically execute such the relationship marketing activities to the customers.

Moreover, this one-to-one business support system provides the following functions to the commodity sales staff. Namely, this system provides a function of supporting a customer analysis to expand an increase in sales, a function of supporting to narrow down a target customer, a function of supporting an issue of a relationship tool, and a function of supporting an estimation and analysis of an action. Further, this one-to-one business support system provides the following functions to the shop manager and salesperson. Namely, this system provides a function of supporting the strength in the ability of suggestion to the customer and a function of supporting the use of the tool for establishing the relationship in the form individualized for each customer.

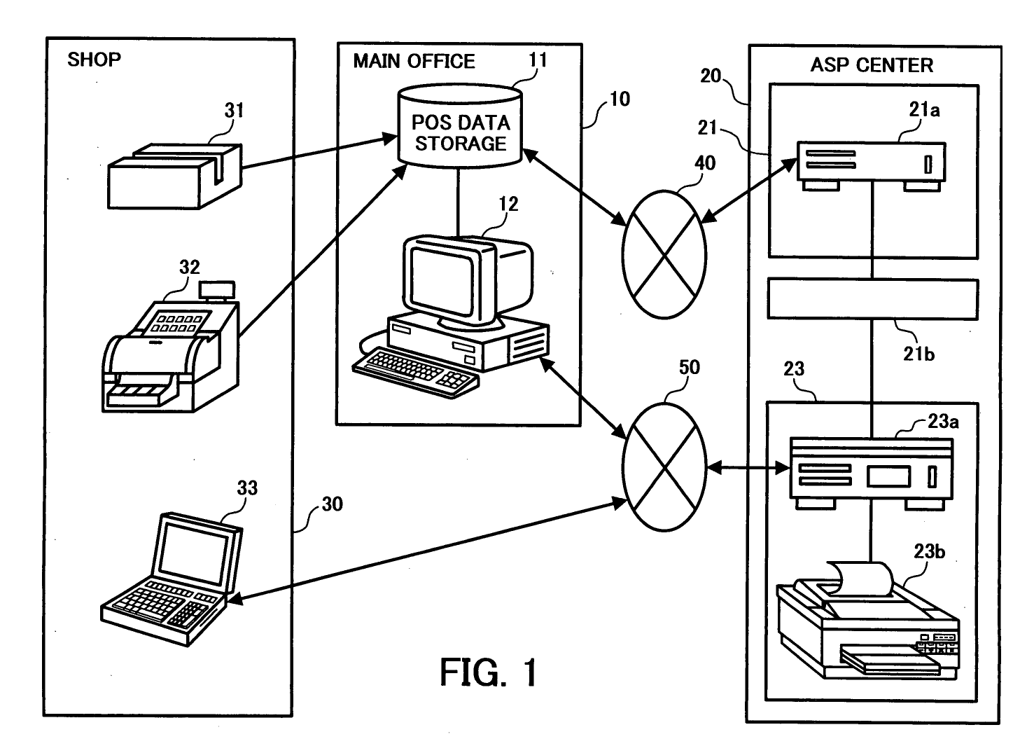

FIG. 1 is a view illustrating a configuration of this one-to-one business support system. In FIG. 1, the one-to-one business support system includes a POS (Point Of Sales) data storage 11, a main office terminal 12, a data management segment 21, a firewall 22, an ASP (Application Service Provider) system 23, a card reader 31, a POS register 32, a shop terminal 33, an IP-VPN (Internet Protocol Virtual Private Network) 40, and an Internet VPN 50. The data management segment 21 includes an AP (application) server 21 a, and the ASP system 23 includes a WeB (Web) server 23a and a printer 23b. Each of the main office terminal 12 and the shop terminal 33 has a computer having a communication control apparatus such as a modem and the like.

The POS data storage 11 is connected to the card reader 31 and the POS register 32 and further connected to the AP server 21a via the IP-VPN 40. The main office terminal 12, the WeB server 23a, and the shop terminal 33 are connected to one another via the Internet VPN 50. The WeB server 23a is further connected to the AP server 21a via the firewall 22.

The POP data storage 11 and the main office terminal 12 are set up at a main office 10 that is run by a client company that sells commodities and services using the one-to-one business support system. The data management segment 21, the firewall 22, and the ASP system 23 are set up at an ASP center 20 that is run by the client company or a third person. The card reader 31, the POS register 32 and the shop terminal 33 are set up at each shop 30 that is run by the client company.

In the client company, the main office 10 performs analysis on the customer based on sales and the like using a result of processing executed by the main office terminal 12 to plan a sales strategy. Each shop 30 executes a one-to-one action to the customer according to the sales strategy planed by the main office 10.

The ASP center 20 provides an application (application program) that supports the one-to-one action to be executed by the shop terminal 33 and implements at least a part of a business scheme to be described later.

Each of the card reader 31, the POS register 32, and the shop terminal 33 includes a communication control apparatus having a modem and the like. The card reader 31 and the POS register 32 obtain customer information and sales information and send them to the POS data storage 11. The customer information is information for specifying the customer and may include, for example, a customer name, address, birthday, and the like. The sales information is information for specifying a business transaction when the customer purchased a commodity, and may include, for example, a trade name, a unit price, the number of purchased commodities, customer information on purchase customer, purchase date, a name of a person in charge who sold the commodity, a name of a shop 30 that sold the commodity, and the like.

The card reader 31 obtains customer information by reading, for example, a membership card delivered to the customer in advance. Moreover, the POS register 32 may obtain customer information and sales information according to an operation done by an operator. In addition, the membership card may be formed of, for example, a magnetic card or an IC (Integrated Circuit) card. The shop terminal 33 includes a personal computer and the like, and connected to the main office terminal 12 and the web server 23a to receive information from the main office terminal 12 and the ASP center 20 or supply information. An apparatus that reads customer information and sales information and sends them to the POS data 11 is not always limited to the card reader 31 and POS register 32, and any apparatus may be used.

The POS data storage 11 includes the storage device of the hard disk device and the communication control apparatus such as a modem and the like, and connected to the main office terminal 12. Then, the POS data storage 11 stores customer information and sales information sent from the card reader 31 or the POS register 32. The main office terminal 12 includes a personal computer and the like and has a communication control apparatus such as a modem and the like. The main office terminal 12 executes a program prestored by itself, and receives an application provided from the ASP center 20 and executes it, and thereby implementing a part of a business scheme to be described later.

The web server 23a provides data to the main office terminal 12, which functions as a client machine according to the program prestored by itself, and the shop terminal 33. The printer 23b is connected to the web server 23a, and prints characters and graphics according to an instruction from the web server 23a. As a result, the one-to-one business support system provides an on-demand print service.

The data management segment 21 and the ASP system 23 provided in the ASP center are connected to each other via the firewall 22, and the data management segment 21 and the POS data storage 11 forms a security capsule zone. The security capsule zone is a zone where security is ensured by a VPN channel provided by the IP-VPN 40. Moreover, security communications using an SSL (Secure Sockets Layer) that implements an encryption of a socket level and an authentication function are performed among apparatuses connected to the Internet VPN 50.

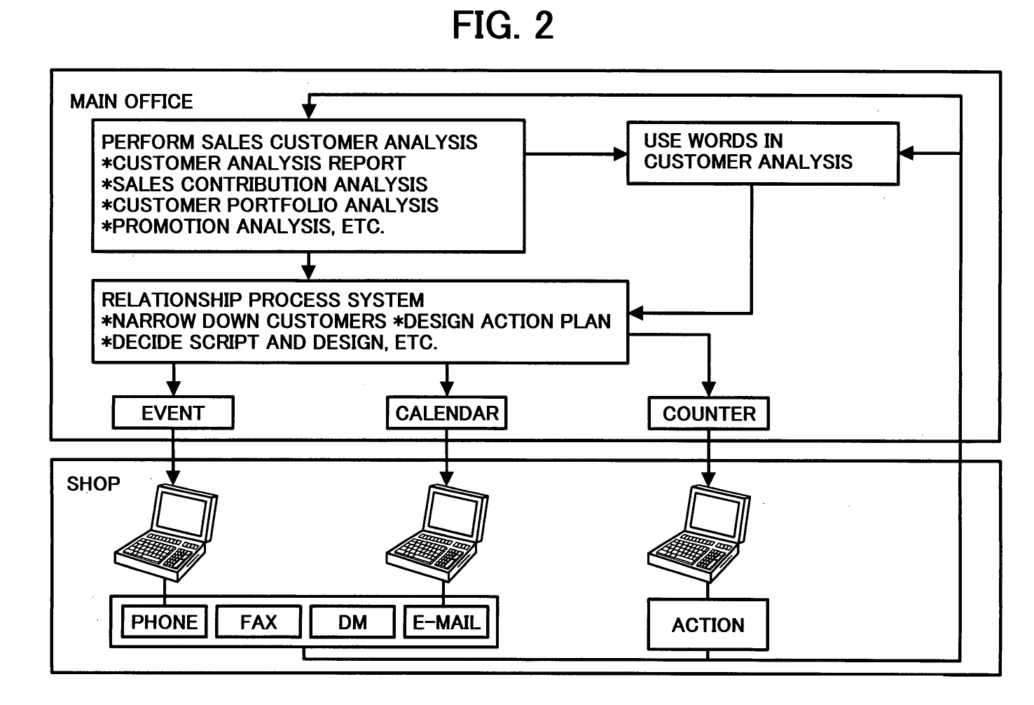

FIG. 2 is a view illustrating a business scheme that is implemented by the one-to-one business support system. The business scheme includes analytical steps having a numerical system analysis and a natural language/knowledge system analysis, a relationship process system step that fixes a strategy and an object based on the analytical result obtained by the analytical steps, and an event system step that executes a one-to-one action to a customer according to a strategy and an object fixed in the relationship process system.

The main office 10 executes the analytical steps based on information sent from each ship 30. In connection with processing that belongs to the analytical system steps, an issue of a customer analytical report, a customer contribution analysis, a customer flow analysis and the like are used as a sales customer analysis based on numerical data. These analyses that belong to the analytical system steps are executed by the main office terminal 12 or the shop terminal 33 according to an operation done by the operator. Since the main office terminal 12 or the shop terminal 33 extracts or analyzes the contents of words uttered by the customer, processing for adding a natural language/knowledge analysis to the words may be executed. The processing to the words may be performed to information (complaint information) indicating a customer complaint relating to the commodity and service and a script of direct mail (DM).

In the relationship process system step, the main office 10 and each shop 30 plan a strategy and an object for selling commodities and services using the analytical result obtained in the analytical system step. Moreover, in the relationship process system step, a customer to which an action should be taken is narrowed down to design an action plan based on the analytical result of a purchase characteristic for each customer and that of a customer attribute. In designing the action plan, it is desirable that an object of an action and a degree of expectation on an effect of the action should be clarified. Furthermore, in the relationship process system step, a script and a design relating to a sales promotion message, which are sent to the customer in the form of DM, are decided for each type of action. Each of the script and the design includes a fixed portion and a variable portion. In the variable portion, a variable item having contents that are different for each action is inserted. The contents of the fixed portion of each of the script and the design may be decided by the main office terminal 12 according to the operation done by the operator. While, regarding the variable item, for example, the main office terminal 12 and the shop terminal 33 prestore data indicating the contents of each action. Then, every time when an action is executed, they may read data indicating the contents to be used in the pertinent action and employ the read data to create DM and the like. Or, the contents of the variable item may be decided according to the operation done by the operator. In addition, the variable item of the DM script may include a bar code indicating a zip code, a customer membership number and an action number (promotion number).

In the relationship process system step, there are used an event system tool for encouraging the customers to come to the shop to improve a sales promotion, a calendar system tool for deepening the relationship with the customers to make them regular customers to improve customer loyalization, or a shop customer service system tool for deepening the relationship with the customers at the shop to improve a sales rate or suggest coordinates.

A certain event system tool includes, for example, an application that is supplied to the main office terminal 12 and the shop terminal 33 from the web server 23a, and causes the main office terminal 12 and the shop terminal 33 to send facsimile for a sales promotion and e-mail to a customer as an object to which a one-to-one action should be taken. Transmission of facsimile and e-mail may be performed in such a way that the main office terminal 12 and the shop terminal 33 gain access to an external facsimile apparatus or mail server via the communication control apparatus provided in each terminal. Moreover, a certain event system tool includes an application executed by the web server 23a and causes the printer 23b to print DM for a sales promotion to be sent to a customer as an object to which a one-to-one action should be taken. The printing is performed according to a request sent to the web server 23a from the shop terminal 33. The shop terminal 33 can select a MD script to be printed by the printer 23b for each customer. For example, when the main office terminal 12 issues an instruction of creating MD to the shop terminal 33, the main office terminal 12 sends multiple MD scripts, which are prestored according to the operation done by an operator of the main office 10, to the shop terminal 33. The shop terminal 33 displays these scripts as candidates. When an operator of the shop terminal 33 selects a specific script from among the displayed candidates and instructs execution, the shop terminal 33 requests the web server 23a to output DM corresponding to the pertinent script. According to the request, the pertinent DM is output from the printer 23b. Moreover, the shop terminal 33 can correct data indicating the contents of DM according to an operation to be done by an operator and control of the application program. As a result, a suitable DM can be created for each customer. The main office terminal 12 can also correct data indicating the contents of DM and request the web server 23a to print DM. Furthermore, the web server 23a may gain access to the external facsimile apparatus and the mail server via the communication control apparatus provided in the web server 23a. In this case, the web server 23a performs the same processing as the aforementioned processing for printing DM, thereby allowing facsimile transmission and e-mail transmission according to the request from the main office terminal 12 and the shop terminal 33.

The calendar system tool includes a program of an application that is executed by the main office terminal 12 and the shop terminal 33. The calendar system tool may set a schedule of outbound using DM, facsimile, e-mail and a schedule of outbound using telephone communication as a calendar for each event (promotion). Then, the calendar system tool causes the main office terminal 12 and the shop terminal 33 to output a message encouraging outbound with predetermined contents and control a program forming the event system tool. The calendar system tool deepens the relationship with the customers to make them regular customers to improve customer loyalization.

Such an outbound schedule setting can be considered that DM is transmitted to a customer, who made a first purchase at the shop, for example, in one week later, 20 days later, one month later, three months later, and six months later since the next day when the customer came to the shop at the first time. A customer to which such a setting can be applied may be limited to a person having a purchase amount or a purchased commodity that meets a fixed condition.

Moreover, DM may be transmitted to a customer on the customer's birthday, his/her family member's birthday or a fixed date one month before these birthday months. DM may be periodically transmitted to a customer, who purchased a specific high-price commodity, after the day when the customer purchased the pertinent commodity. When customers are classified into multiple ranks based on a predetermined criterion, a customer to which DM should be transmitted may be limited to a customer belonging to a predetermined rank. Moreover, DM may be transmitted periodically throughout the year instead of using a specific date as a criterion. Furthermore, when the commodity is, for example, clothes, in order to send DM to a customer on a predetermined month (for instance, odd month), the contents of each DM may be set to describe a hint about the style of dress according to the season when the pertinent DM is transmitted.

Moreover, a next visit date is predicted using data indicating a customer's purchase frequency so that DM may be sent to the customer at a predetermined time based on the obtained predicted date. This prediction may be executed by obtaining an average time interval when a customer visits the shop 30 and purchases a commodity based on a purchase frequency and adding the obtained time interval to a latest visit date. The prediction of the visit date may be executed by a person and a prediction result may be input to the main office terminal 12 and the shop terminal 33. Or, the main office terminal 12 and the shop terminal 33 may execute a program such as an application to predict the visit date.

The shop customer service system tool includes a program such as an application that is executed by the main office terminal 12. The shop terminal 12 that executes the shop customer service system tool confirms the past purchased commodities for each customer, and displays customer data recorded on the POS data storage 11 on the shop terminal 33 in the form of a customer service screen or a customer information screen to be described later. For example, when the card reader 31 set up at the shop 30 obtains customer attribute information from the membership card and transmits it to the POS data storage 11, the POS data storage 11 receives the attribute information to store. When the POS register 32 set up at the shop 30 transmits input sales information to the POS data storage 11, the POS data storage 11 receives the sales information to store, and customer data is thereby collected. Moreover, customer data obtained from bar code information read by a bar code reader and customer data obtained by use of a reader using RF-ID or a reader using infrared communication may be collected.

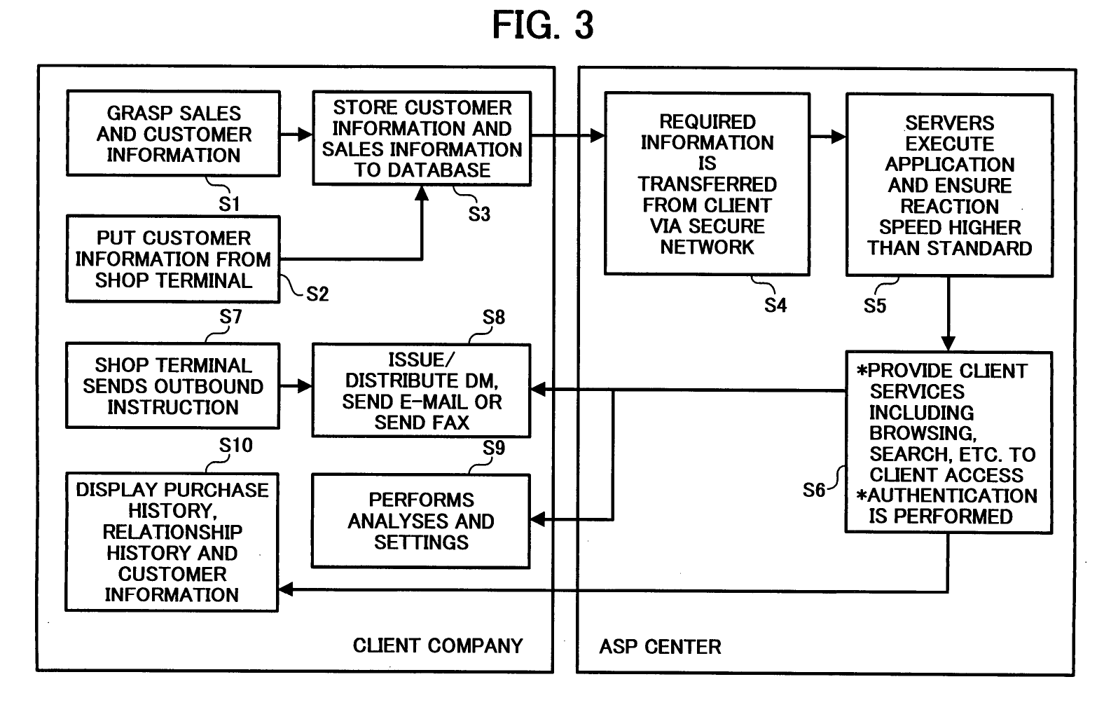

FIG. 3 is a view explaining a workflow of the aforementioned various kinds of processing executed to implement the above-explained business scheme. First of all, customers and sales at the shop 30 of the client company are grasped (FIG. 3, step S1). More specifically, in step S1, the reader such as the card reader 31, the bar code reader, the reader using RF-ID, information reader using infrared communication, and the like reads customer information that identifies a customer from the customer membership card and the ID card, and sends it to the POS data storage 11. The read customer information is associated with sales information that is generated by the POS 32 according to the operation done by the operator and is supplied to the POS data storage 1.

Moreover, the operator of the client company can operate the shop terminal 33 to input customer information to the shop terminal 33 and sends it to the POS data storage 11 (step S2).

Sales information and customer information collected by the shop 30 as a sales contact of the client company are stored to the POS data storage 11 set up at the main office 10 of the client company (step S3).

Then, the POS data storage 11 transfers data necessary for the following processing to the AP server 21a of the ASP center 20 via IP-VPN 40 (or another network whose security is ensured) (step S4). When an operator of the ASP center 20 finds out abnormality and unclear points in data transferred in step S4, the operator asks the client company and corrects the pertinent data.

The ASP center 20 includes multiple servers such as the web server 23a that perform the execution and supply of the application in addition to the AP server 21a that stores data. The ASP center 20 performs operations according to the requests from the apparatuses provided in the main office 10 and the shop 30 of the client company at reaction speed, which is higher than standard that these apparatuses need, while ensuring the safety of the one-to-one business support system (step S5).

Then, the ASP center 20 provides services, which include browsing, search, instruction and the like, to the client company using a web browser and the like (step S6). More specifically, for example, the web server 23a supplies a program that implements the pertinent service to the main office terminal 12 and the shop terminal 33. In addition, the ASP center 20 may allocate authentication information such as an ID and a password to the client company and perform access authentication using the authentication information at the time of using the service. The ASP center 20 may perform authentication using a biometrics technique such as a fingerprint system as required in order to ensure the security. More specifically, the ASP center 20 causes the main office terminal 12 and the shop terminal 33 to obtain an image of a fingerprint of the operator of the client company and performs authentication based on the obtained image. In this case, the main office terminal 12 and the shop terminal 33 may have a scanner that reads the fingerprint.

While, the operator of the client company can operate the main office terminal 12 and the shop terminal 33 to send an instruction of outbound to the main office terminal 12 and the shop terminal 33 (step S7). This instruction is transferred to the web server 32a of the ASP center 20.

The web server 23a performs printing of DM and transmission of e-mail or facsimile in response to the outbound instruction (step S8). The main office terminal 12 and the shop terminal 33 may execute an application supplied from the web server 23a or a program stored in each terminal and thereby performs transmission of e-mail or facsimile by themselves.

Moreover, the main office terminal 12 of the client company may execute an application supplied from the web server 23a or a program stored therein and thereby performs various kinds of analyses belong to the aforementioned analytical system step, rule settings (for example, setting of parameters used in analysis, setting of a condition for narrowing down the customer as an object to be analyzed, and the like), and contents setting (for example, fixed portions of the DM script and design and the like) (step S9).

Furthermore, the shop terminal 33 can output sales information and customer information input in the past and an execution history of the processing relating to the relationship process system step in the form that they are displayed on the display screen of a display provided therein (step S10). In step S10, for example, the shop terminal 33 may display a pop-up window where customer information is described in response to the fact that the card reader 31 read customer information from the card. However, in this case, it is assumed that the card reader 31 is connected to the shop terminal 33 and the card reader 31 supplies the read customer information to the shop terminal 33. Moreover, in step S10, among sales information and customer information stored in the shop terminal 33, the shop terminal 33 may search information matching with a condition input by the operator or other condition and display the searched information. More specifically, it can be considered that searching will be performed using a customer name described by 50 Japanese characters or alphabets, a name of the purchased commodity, and a purchase date as a search key. In addition, the shop terminal 33 may receive the input of the operator's ID and password to perform authentication, and execute processing in step S10 only when the operator succeeds in authentication. Moreover, the shop terminal 33 may limit the range of searching data according to the authenticated ID.

Furthermore, the shop terminal 33 may display the customer service screen according to the operation done by the operator. The customer service screen is a screen that includes attribute information, a customer rank, a past purchase commodity history, a relation history with the past customer, the largest selling commodity and commodity-related purchase information and the like. The salesperson at the shop offers service using the customer service screen, so that the salesperson can make full use of the customer service screen to improve an increase in sales, and to deepen the relationship with the customer to increase the customer's loyalty. Since the customer purchase history and relation history can be displayed on the customer service screen for a designated period of time, they can be displayed in table form that is sortable for each item.

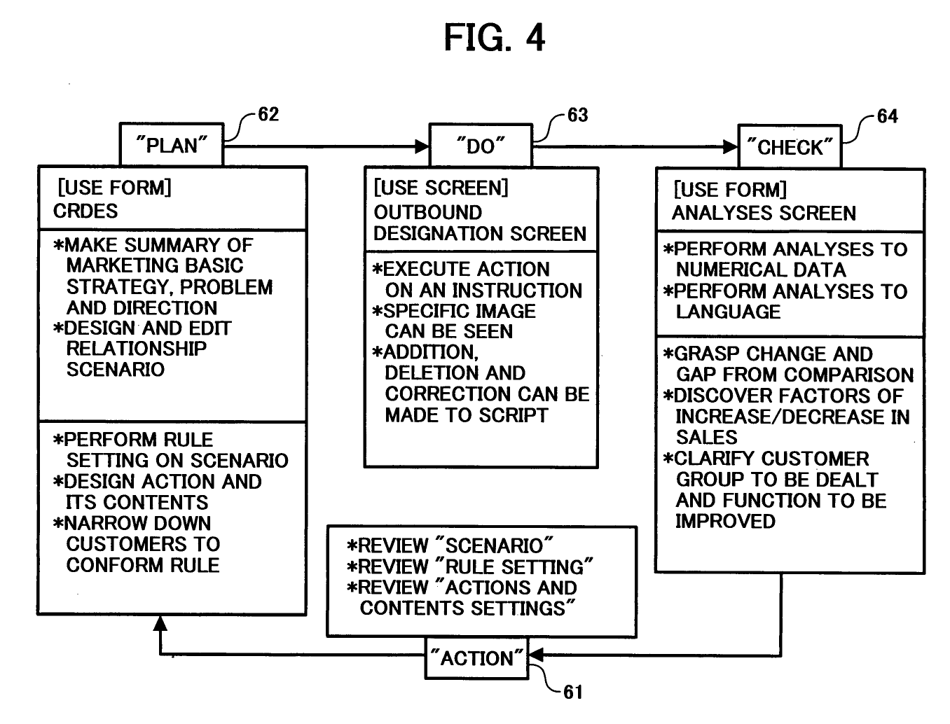

FIG. 4 is a view explaining a workflow of management for optimizing processing that is executed to implement the aforementioned business scheme. As illustrated in FIG. 4, the client company fixes a business strategy based on, for example, the result of the analytical system step performed in the past using the one-to-one business support system, and prepares execution of the one-to-one outbound (plan step 62). Next, the client company executes outbound according to the pertinent strategy prepared in the plan step S62 (do step 63). Next, the client company performs processing relating to the analytical system step using, for example, the one-to-one business support system and thereby executes analytical evaluation of outbound executed in the do step 63 to discover a problem (check step 64). Next, the client company takes measures against the problem based on the analytical result obtained in the check step 64 (action step 61). Then, the client company returns to the plan step 62 and fixes a new business strategy based on the measures taken in the action step 61, and prepares execution of the one-to-one outbound again. Afterward, the client company executes plan step 62 to action step 61 in a circulating manner to perform management.

Specifically, in the plan step 62, at first, the client company makes a summary of each of the marketing basic strategy, current problem, and direction. Then, the client company uses, for example, CRDES (Customer Relationship Designing and Editing Sheet) as a form, and spits a series of processes where the customer is involved in the commodity purchase into a stage structure, and designs and edits a relationship to be formed between the client company and the customer in the form of scenario.

Moreover, in the plan step 62, the client company performs a rule design based on the scenario to prepare outbound execution. The rule design includes a task of setting a condition for narrowing down the client and a task of setting a type and contents of an action to a client satisfying the pertinent condition. The main office terminal 12 and the shop terminal 33 provides an initialization module 170 to be described later and supports the rule design. In addition, a person may perform the rule design and input the design result to the main office terminal 12 and the shop terminal 33.

An explanation will next be given of the do step 63. When the main office terminal 12 and the shop terminal 33 execute processing relating to the do step 63, they display an outbound designation screen (for example, DM transmission selection screen and the like) according to, for example, a program that controls this processing. The outbound designation screen provides GUI (Graphical User Interface) to the operator of the main office terminal 12 and that of the shop terminal 33. The outbound designation screen is a screen including columns each having a text showing each action set in the plan step 62 and check columns, which respectively correspond to the aforementioned columns on a one-to-one basis. Then, when the operator inputs a symbol and the like instructing execution of an action in the check column, the main office terminal 12 and the shop terminal 33 execute processing corresponded to the check column in which the symbol and the like are input in response to this instruction. When multiple actions are instructed to the same customer within a predetermined period of time, the main office terminal 12 and the shop terminal 33 may display that there are overlapped instructions to the same customer. Moreover, the main office terminal 12 and the shop terminal 33 may display a preview screen in response to the instruction from the operator and show a specific progress of processing whose execution is instructed within the preview screen. Furthermore, regarding processing that is already executed, the main office terminal 12 and the shop terminal 33 may display a confirmation screen showing execution is already done. Moreover, regarding processing that is not yet executed among processing displayed on the outbound designation screen, the main office terminal 12 and the shop terminal 33 may perform addition and deletion of the contents of the pertinent processing in response to the instruction from the operator. More specifically, for example, in the case where the pertinent processing is the printing of DM, addition and deletion of the DM script and design are performed and a program that controls the printing of DM is added and deleted.

An explanation will next be given of the check step 64. In the check step 64, the outbound executed in the do step 63 is analyzed and estimated to discover a problem. In order to analyze and estimate the outbound and support these tasks, the main office terminal 12 and the shop terminal 33 execute an application supplied from the web server 23a or a program stored in each terminal to perform a numerical data system analysis. The numerical data system analysis includes a sales analysis, a customer contribution analysis, a customer flow analysis, a customer life time analysis, a customer attribute analysis, a promotion analysis, a customer trace analysis, and the like. Moreover, the main office terminal 12 and the shop terminal 33 may further perform analysis that extracts words, which show a customer's complaint, inquiry, and request, from his/her voice, analysis that extracts words of a salesperson in charge from his/her voice, and analysis that extracts characters from the script of DM as the aforementioned natural language/knowledge analysis.

In order to discover a problem or support it, the main office terminal 12 and the shop terminal 33 execute an application supplied from the web server 23a or a program stored in each terminal to perform processing described later. As a result, the client company grasps a change and a gap from comparison in plan, comparison in time, external comparison and the like, making it easy to discover a main factor of an increase/decrease in sales as considering timing and situations.

Specifically, in the action step 61, the client company executes (1) a review of a scenario, (2) a review of a rule setting, and (3) a review of an action and contents setting.

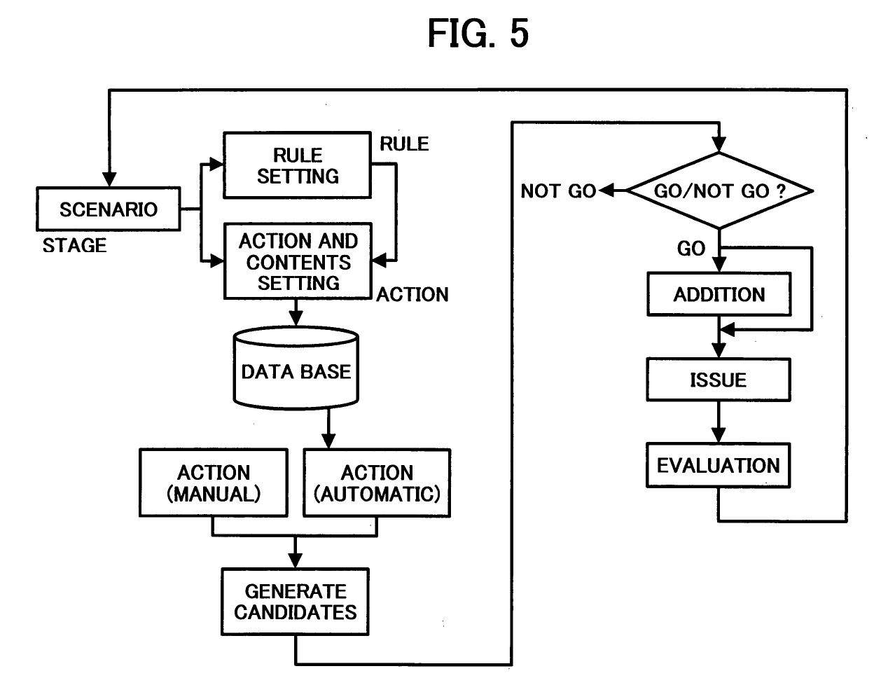

FIG. 5 schematically explains a process including the generation of an action plan based on the aforementioned scenario to the issue of a tool according to the plan.

As illustrated in the figure, the client company performs a rule design based on a scenario created using CRDES and the like, and stores a result of the rule design to the POS data storage 11 by operating the main office terminal 12 and the shop terminal 33. The main office terminal 12 and the shop terminal 33 narrow down the customer automatically according to the rule design, and execute an action to the narrowed-down customer or support the execution. The customer may be manually narrowed down by an operation from the operator. Then, the main office terminal 12 and the shop terminal 33 display a screen showing a customer to which an action should be taken, and the client company checks the contents shown by the pertinent screen. Then, the client company inputs execution of an action (inputs “GO”) if the action is executable. When the client company determines that addition and correction are needed to the script of the tool used in the action, the client company performs addition and correction by operating the main office terminal 12 and the shop terminal 33, and thereafter inputs GO. The client company evaluates a client's reaction after executing the action, and feeds an evaluation result back to the scenario.

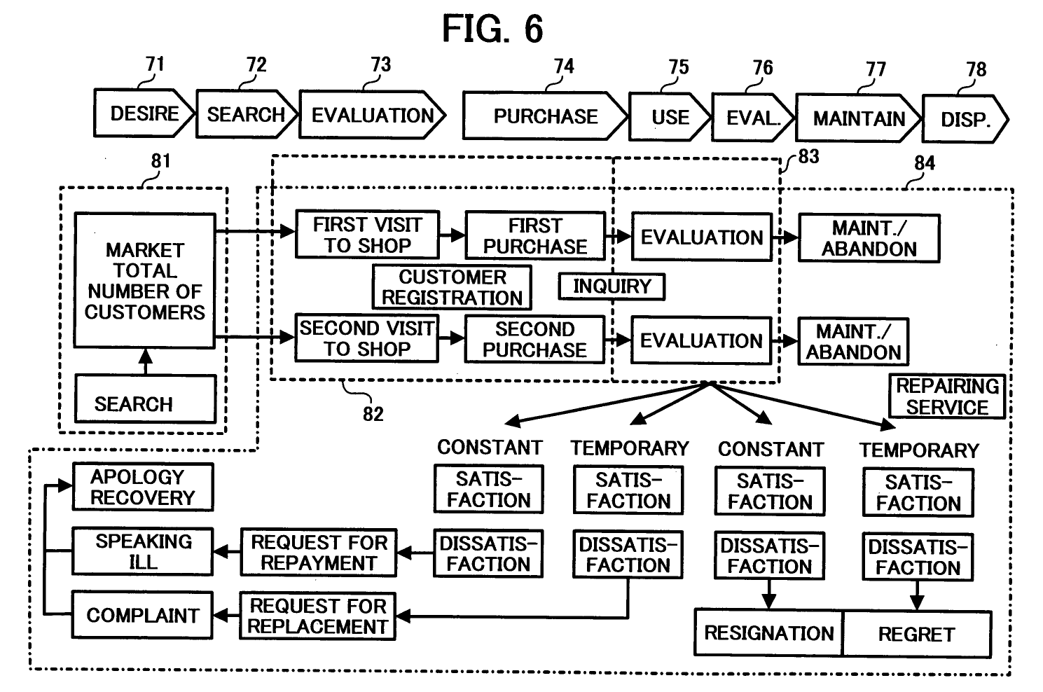

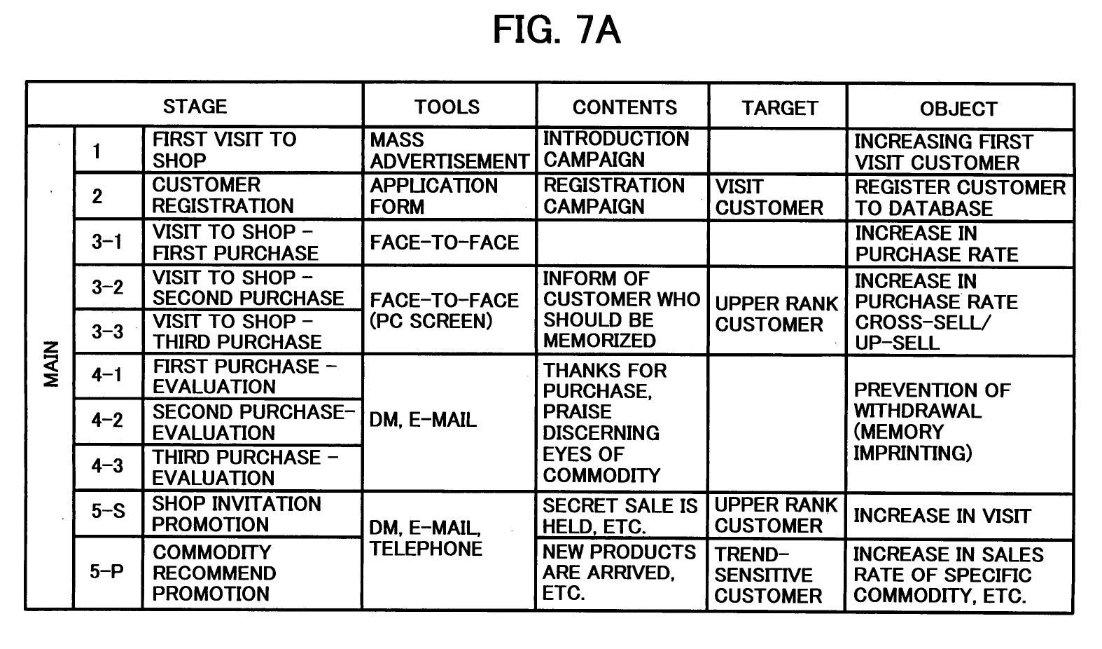

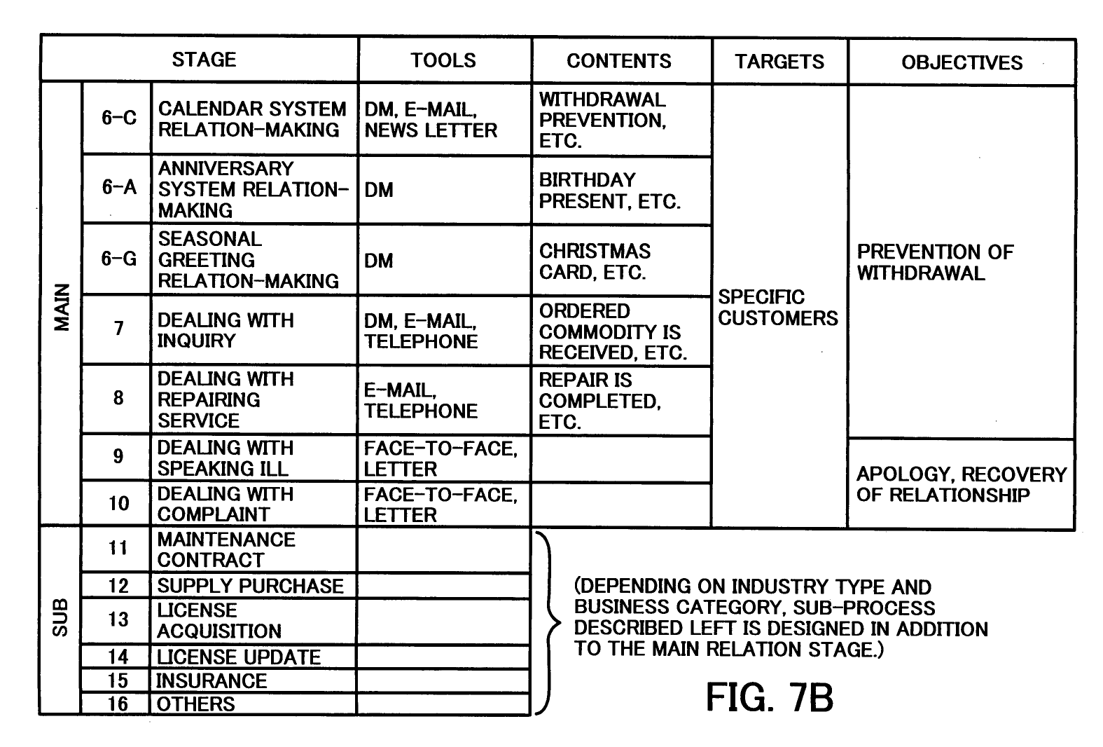

FIG. 6 is a view explaining a concept in which a series of processes where the customer is involved in the commodity purchase is split into a stage structure at the time of setting a scenario for fixing a strategic object. Moreover, FIGS. 7A and 7B are views explaining stages in FIG. 6. In the explanation set forth below, it is assumed that this process undergoes the respective steps of a desire for purchase 71, an information search 72, an evaluation 73 of an alternative before purchasing a commodity, a commodity purchase 74, a commodity use and consumption 75, an evaluation 76 of an alternative after purchasing a commodity, a commodity maintain 77, and a commodity temporary disposal or permanent abandon 78. Among these steps, in the steps including the desire for purchase 71 to the purchase 74, external environment of the customer has a strong influence upon a client's action. While, after purchasing the commodity, the client's action largely differs for each client.

Grasping the client's action based on such a concept arouses a desire for a next commodity purchase. Also, the burden imposed on the customer who performs information searching activity is lightened, and this is useful for leading a pre-purchase evaluation process to a direction, which is advantageous to the client company, to implement a customer groove-in.

The following will explain the action of outbound in which the action (stage) relating to the process shown in FIG. 6 is classified into four types including mass marketing 81, in-store promotion 82, use to post-purchase evaluation 83, and experience and storage 84 as illustrated in the figure to form the contents of each stage.

First of all, in the mass marketing 81, the client company that runs the main office 10 and the shop 30 performs mass marketing to all customers in the market of a commodity that the client company will sell. Moreover, the customer, who is out of the market and conducts an information search taking his/her cue from long-period storage resulting from the customer's experience (this is a so-called “mind-set meaning information), is considered as a customer who is in the market.

In the in-store promotion 82, first of all, as stage 1, in order to encourage a potential customer to come to the shop, the client company places an advertisement in a magazine and other mass media, execute an acquaintance introduction campaign, and sends MD for an acquaintance introduction. In order to support the actions such as the description in the advertisement, the dispatch of DM and the like, for example, the main office terminal 12 and the shop terminal 33 may execute an application supplied from the web server 23a or a program stored in each terminal to create a document for advertisement or cause the printer 23b to print DM according to the operation from the operation.

Then, as state 2, the main office terminal 12 and the shop terminal 33 pass out a leaflet and an application blank, which encourage the customer to register, to the customer who has come to the shop. Herein, a customer registration campaign to promote the registration to a customer DB is conducted. In stage 2, to support the action that distributes the leaflet and the application blank, for example, the main office terminal 12 and the shop terminal 33 may execute an application supplied from the web server 23a or a program stored in each terminal to create a document for the leaflet or the application blank or cause the printer 23b to print the leaflet or the application blank according to the operation from the operation.

Then, in stage 3, the salesperson of the shop of the client company will establish the relationship with a new customer on a face-to-face basis. For example, the salesperson offers service to the new customer on a face-to-face basis to increase a purchase rate of the pertinent customer. Moreover, the client company issues the aforementioned membership card to the pertinent customer, or operates the ship terminal 33 to input information on the pertinent customer and stores it to the shop terminal 33 and the POS data storage 11. When the salesperson offers service to the customer, who comes to the shop two times or more, the salesperson operates the shop terminal 33 to display information on the pertinent customer thereon as a customer service screen. Information on the customer can include information that forms the aforementioned customer information, commodities that the customer purchased in the past, the contents of the complaints that the pertinent made in the past, and the like. Further, the shop terminal 33 may extract a customer, whose name should be memorized by the salesperson, from customers with high customer ranks to be described later and other specific customers according to a predetermined criterion based on information on the customer stored in the POS data storage 11, and display the name of the extracted customer. Furthermore, the shop terminal 33 may extract a customer, whose name should be memorized by the salesperson, from customers with high customer ranks to be described later and other specific customers according to a predetermined criterion based on information on the customer stored in the POS data storage 11, and display the name of the extracted customer in the customer service screen. Moreover, the shop terminal 33 may extract purchase information on the top selling commodities relating to the commodities purchased in the past by the service-offering customer according to a predetermined criterion based on information on the pertinent customer, and display the extracted purchase information in the customer service screen. Then, the salesperson offers service to the customer with reference to the information displayed in the customer service screen and deepens the relationship with the customer.

Next, in state 4, the client company conducts a promotion to the customer who purchased the commodity using DM or e-mail. Creation and transmission of e-mail are performed by the main office terminal 12 and the shop terminal 33 according to the operation from the operator. Decision and printing of the DM script and design are performed by the web server 23a and the printer 23b according to the operator of the main office terminal 12 and that of the shop terminal 33. It is assumed that the text of e-mail and DM script include thanks for purchase and words that praise the customer for his/her discerning eyes of commodity. The POS data storage 11, the main office terminal 12 or the shop terminal 33 may store such words as those that form the fixed portion of the pertinent script. As a result, for example, it can be expected that memory of the shop will be imprinted in the customer's mind and the customer will be prevented from withdrawing from the relationship with the client company. In addition, any words that are determined as being useful in the light of a cognitive dissonance theory may be included in the text of e-mail and DM script.

On the other hand, the customer, who purchased the commodity, conducts post-purchase evaluation in the step of the use to post-purchase evaluation. Then, the customer maintains the commodity and abandons it at some point in time in the steps of commodity maintenance/abandon.

More specifically, in the step of use to post-purchase evaluation 83, the customer evaluates whether he/she satisfies the commodity and service of the shop as the post-purchase evaluation. The objective factor of this evaluation may include a cause resulting from the shop side and a cause resulting from the customer. The evaluation of satisfaction/dissatisfaction may include constant and temporary evaluations. Then, for example, it can be considered that constant dissatisfaction caused by the customer produces feeling of resignation in the customer, and temporary dissatisfaction caused by the customer produces feeling of regret in the customer.

In the case where dissatisfaction is caused by the shop, it can be considered that the customer having a constant dissatisfying feeling requests repayment or speaks ill of the shop. When the customer speaks ill of the shop, in stage 9, the client company offers an apology to the customer on a face-to-face basis or by mail, or executes an action for a recovery of the relationship. Moreover, in the case where dissatisfaction is caused by the shop and the customer has a temporary dissatisfying feeling, it can be considered that the customer requests a replacement for the commodity or makes a complaint to the shop and the commodity. When the customer makes a complaint, in stage 10, the client company answers to the complaint on a face-to-face basis or by mail, or executes an action for an apology or recovery of the relationship.

The evaluations of the client company made by the customers can be known to the client company when the client company sends out questionaries to the customers and collects them in addition to the aforementioned complaints, speaking ill of the shop, request for a repayment, and request for a replacement. Then, when the operator of the client company operates the main office terminal 12 and the shop terminal 33 to input information indicating the evaluations of the client company made by the customers and the aforementioned natural language/knowledge analysis is further instructed as required, input information or information obtained by providing the natural language/knowledge analysis to the input information is stored by the POS data storage 11. Accordingly, the one-to-one business support system stores information indicating the evaluations. Similarly, the one-to-one business support system also stores information on the apology to the customers, and information indicating the outline and the result of the actions for recovering the relationship. Then, these information items are used as information for supporting to recall the salespersons of the shop 30 of memories relating to the customers.

Moreover, when there is an inquiry about, for example, an ordered commodity, a held commodity, and the like from the customer, notification about the ordered commodity and the held commodity is sent from the shop, in stage 7, the customer is notified by DM, e-mail, or telephone that the ordered commodity is received or commodity holding time expires.

Furthermore, the client company executes an action for encouraging the customers to come to the shop to prevent them from withdrawing from the shop. Regarding this type of action, for example, in stage 5, a shop invitation system promotion or a commodity recommend system promotion or both are executed.

The shop invitation system promotion is an action that invites the customer to come to the shop. Regarding the shop invitation system promotion, the client company extends an invitation to a secret sale, an invitation to other special sales, an invitation to other event to the customer who conforms to a predetermined condition (for example, a customer whose loyalty or rank is more than a predetermined degree) by, for example, DM, e-mail, or telephone. Moreover, for example, the client company executes an invitation, which is carried out according to the weather at the location of the shop 30 and other circumstances, notification that a competitor conducts an event, an invitation to other campaign to the customer, who is, for example, a commuter working in the vicinity of the shop 30. The main office terminal 12 and the shop terminal 33 may extract a customer to be subjected to the shop invitation system promotion by executing an application supplied from the web server 23a or a program stored by each terminal based on information stored by each terminal or the POS data storage 11.

The commodity recommend system promotion is an action that recommends a customer a specific commodity or a commodity that conforms to a fixed condition. Regarding the commodity recommend system promotion, by the client company, a customer, who is regarded as “a customer who is sensitive to the trends” in the light of a predetermined criterion, is notified of the arrival time of a new product or a market introduction time by use of DM, e-mail, or telephone. In addition, a customer, who is regarded as “a customer who is sensitive to the quantity of assortment of commodities” in the light of a predetermined criterion, may be notified that abundant commodities can be prepared. A customer, who needs a specific commodity, may be notified that a commodity needed by the customer is arrived. A customer, who is in a situation that a desired commodity is out of stock, may be notified that the desired commodity, which was out of stock, is received. The main office terminal 12 and the shop terminal 33 may extract a customer to be subjected to the shop invitation system promotion by executing an application supplied from the web server 23a or a program stored by each terminal based on information stored by each terminal or the POS data storage 11.

Furthermore, in stage 6, the client company may perform any one of a calendar system relation-making, an anniversary system relation-making, and a seasonal greeting relation-making or any two or more thereof in order to imprint the memory of the shop in the customer, who has come to the shop one time or more, to encourage the pertinent customer to come to the shop and to prevent the customer from withdrawing from the shop.

The calendar system relation-making is an action that is provided to the pertinent customer taking a cue from the arrival of the date that is set by the client company side. Regarding the calendar system relation-making, when a predetermined date arrives (or is nearing), the client company sends a message to a customer, who satisfies a predetermined condition that is determined by the relation with the pertinent date, by DM, e-mail, or newsletter. More specifically, messages explained below may be set to a customer, who is in a situation that a fixed period of time has elapsed since his/her purchase of commodity. Namely, the messages includes a message asking whether there is a defect in the purchased commodity, a message reporting a way of maintaining the purchased commodity, a new way of using, a way of enjoying, and the like, and a message that transmits the policy of the client company, that of each shop, and that of each salesperson. Furthermore, when a next purchase date, which can be predicted in the light of the customer's past commodity purchase pattern, arrives or the pertinent date is nearing, a message, which introduces the client company or the shop again to prevent the customer from withdrawing from the client company or the shop, may be sent to the pertinent customer.

Additionally, in the one-to-one business support system, it is assumed that the main office terminal 12 or the shop terminal 33 includes, for example, a timer that continuously generates time and date information showing current time and date in order to detect the arrival of a predetermined date. The main office terminal 12 or the shop terminal 33 may repeatedly refer to the current time shown by the timer. Or, the one-to-one business support system may obtain time and date information from an external section via a network and the like and refers to the obtained information. Regarding the extraction of a customer to be subjected to the calendar system relation-making performed taking a cue from the specific date and the prediction of the client's commodity purchase date, in the one-to-one business support system, the main office terminal 12 and the shop terminal 33 may perform the extraction and the prediction by executing an application supplied from the web server 23a or a program stored by each terminal based on information and the pertinent date that are stored by each terminal or the POS data storage 11.

The system anniversary system relation-making is an action that is provided to the pertinent customer taking a cue from the arrival of the special anniversary day unique to the customer. Regarding the anniversary system relation-making, when an anniversary day unique to the customer arrives (or is nearing), the client company may send a message to the pertinent customer by DM or e-mail. More specifically, for example, when a customer's birthday arrives or is nearing, the client company may send a message stating that a birthday present is handed to the customer when he/she comes to the shop. When a customer's marriage anniversary day arrives or is nearing, the client company may send a message celebrating the marriage anniversary day. Furthermore, a message relating to a removal may be sent to a customer whose house or office has moved. Additionally, in the one-to-one business support system, for example, the POS data storage 11 may prestore an anniversary day unique to the customer, meanwhile the main office terminal 12 or the shop terminal 33 may repeatedly refer to the aforementioned time and date information and compare with the anniversary day, thereby detecting the arrival of the anniversary day. Furthermore, the client company may limit the customer to be subjected to the anniversary system relation-making to a person, who satisfies a fixed condition (for example, a customer whose rank (to be described later) is more than a predetermined degree). Then, the one-to-one business support system may extract a customer to be subjected to the anniversary system relation-making. Regarding the extraction of a customer to be subjected to the anniversary system relation-making, the main office terminal 12 and the shop terminal 33 may perform the extraction by executing an application supplied from the web server 23a or a program stored by each terminal based on information stored by each terminal or the POS data storage 11.

The seasonal greeting relation-making is an action that is provided to a customer as a seasonal greeting. Regarding the seasonal greeting relation-making, when a predetermined date (for example, a new year day) arrives (or is nearing), the client company sends a message including a seasonal greeting to the client by DM or e-mail. Additionally, in the one-to-one business support system, for example, the main office terminal 12 or the shop terminal 33 may repeatedly refer to the aforementioned time and date information to detect the arrival of a predetermined date. Words of various kinds of messages may be stored as the fixed portions of DM script and e-mail by the POS data storage 11, the main office terminal 12, or the shop terminal 33.

An explanation will next be given of a rule setting, which is performed by the client company in the aforementioned step 62, and processing, which is executed by the one-to-one business support system in order to support the rule setting. Each is information, which defines a condition for narrowing down a customer and is decided based on a scenario. It is assumed that a rule number unique to the pertinent rule is allocated to each rule. Then, the one-to-one business support system causes the main office terminal 12 and the shop terminal 33 to display a rule setting screen and obtains information indicating a rule according to an operation from an operator of the main office terminal 12 or the shop terminal 33 to store it to the POS data storage 11, thereby performing storage of the rule.

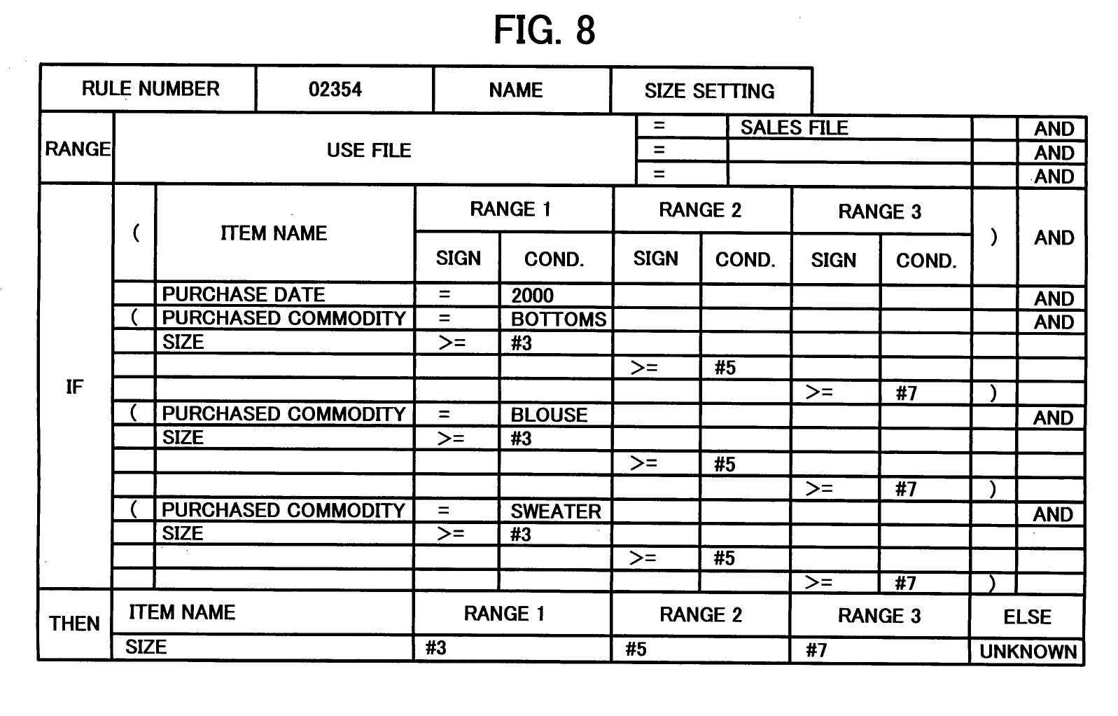

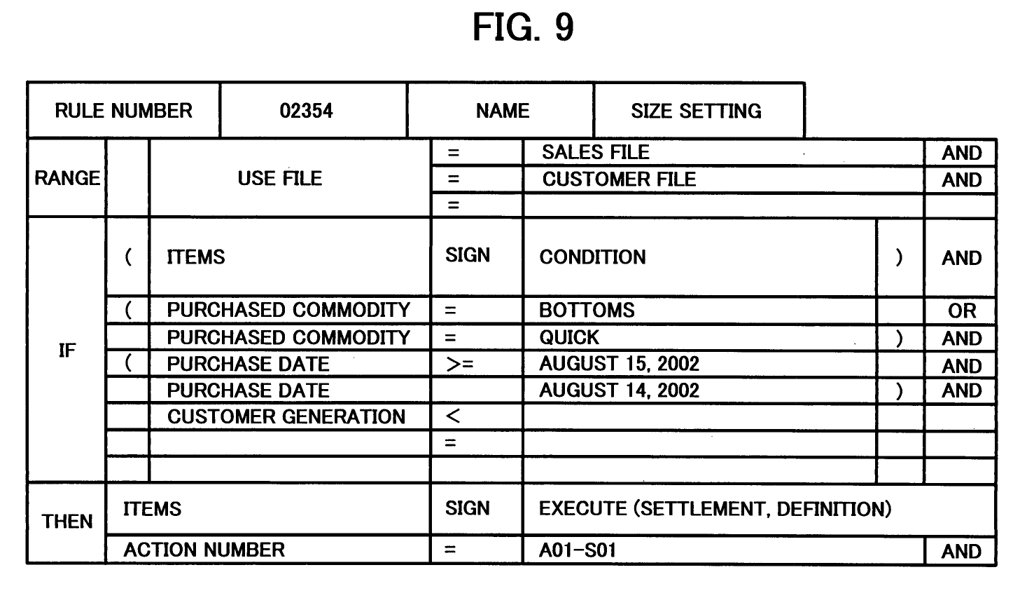

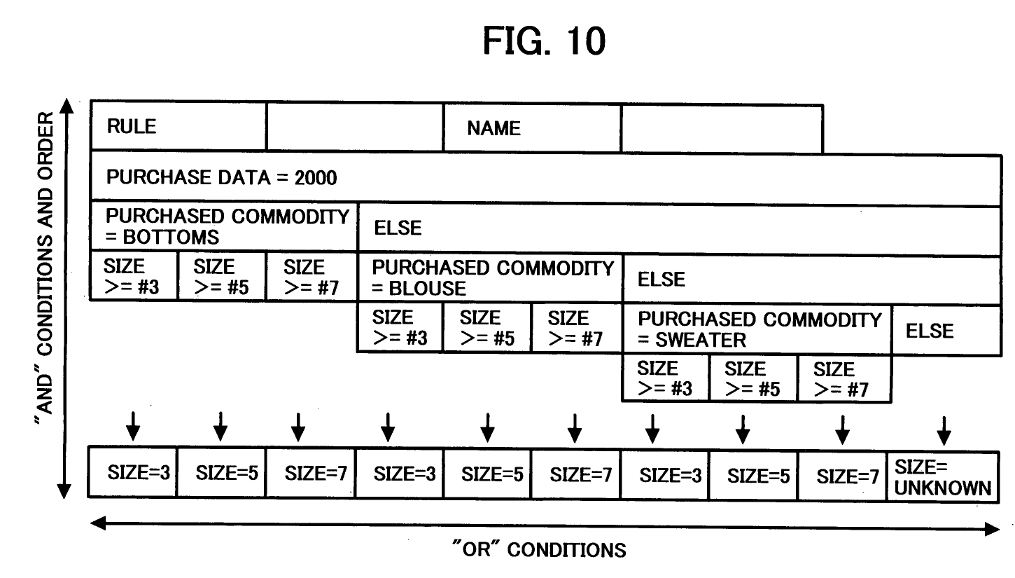

FIGS. 8 to 10 are views each illustrating a rule setting screen. The rule setting screen is a screen that is displayed to provide GUI to the operator, and includes a rule setting section and a rule displaying section. The rule setting section includes a table type and an individual type. FIG. 8 is a view illustrating a rule setting section of a table type, FIG. 9 is a view illustrating a rule setting section of an individual type, and FIG. 10 is a view illustrating a rule display section.

The table type rule setting section has a function of executing a table setting and replacement and makes it possible to define “a customer who is sensitive to the trends” and “a customer who is sensitive to the assortment of commodities” based on the sold commodity and sales day.

The table setting section illustrated in FIG. 8 shows an example that fixes a rule relating to a size set of clothing at a clothing shop. Herein, a condition is fixed for each item name to set a rule for each condition. The-main office terminal 12 and the shop terminal 33, which display the table type rule setting section, automatically adds a rule number that is allocated to each set rule.

FIG. 10 shows a screen (rule displaying section) that displays a rule set by the table type rule setting section of FIG. 8. The rule setting section also displays a complicated rule setting understandably. The added rule number is also displayed in the rule displaying section.

The individual type rule setting section has a function of designating an individual action. The individual type rule setting section illustrated in FIG. 9 shows an example that fixes a rule relating to thanks to a customer for purchasing a commodity. The use of the individual type rule setting section makes it possible to set an action individually when an operator inputs an item name and a condition.

The client company, which set the rule in the plan step 62, sets the contents of an action to be executed when each set rule is applied based on a scenario. Then, the one-to-one business support system causes the main office terminal 12 and the shop terminal 33 to display a contents setting screen to be described later and obtains information indicating the contents according to an operation from an operator of the main office terminal 12 or the shop terminal 33 to store them to the POS data storage 11, thereby performing storage of the contents.

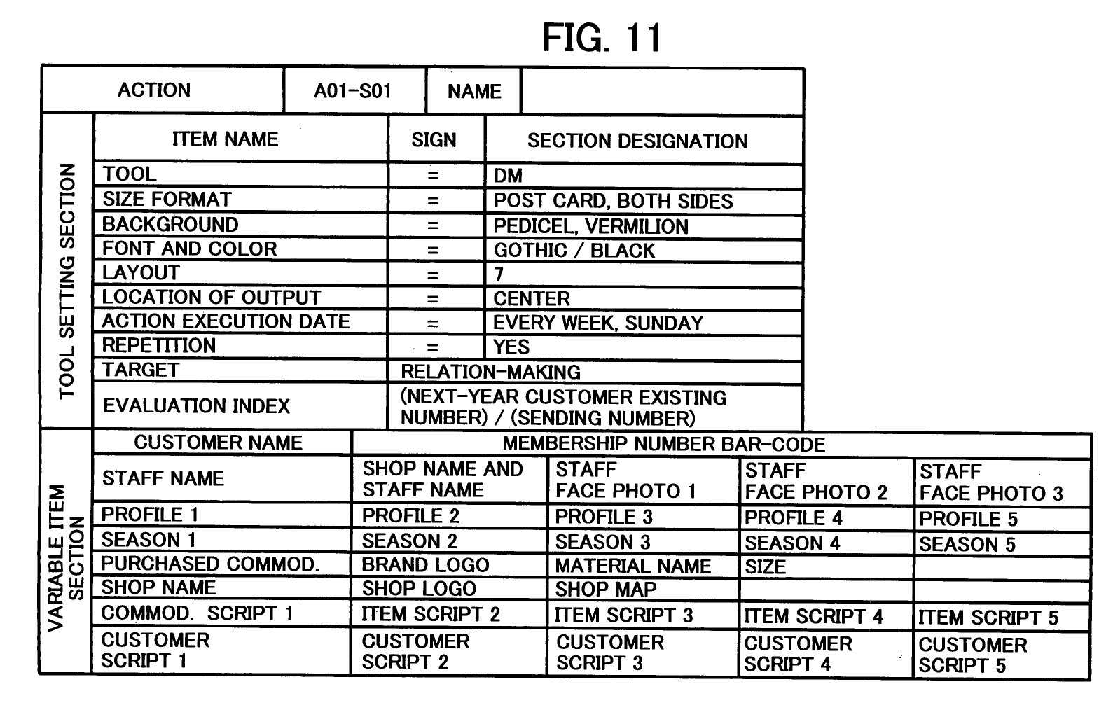

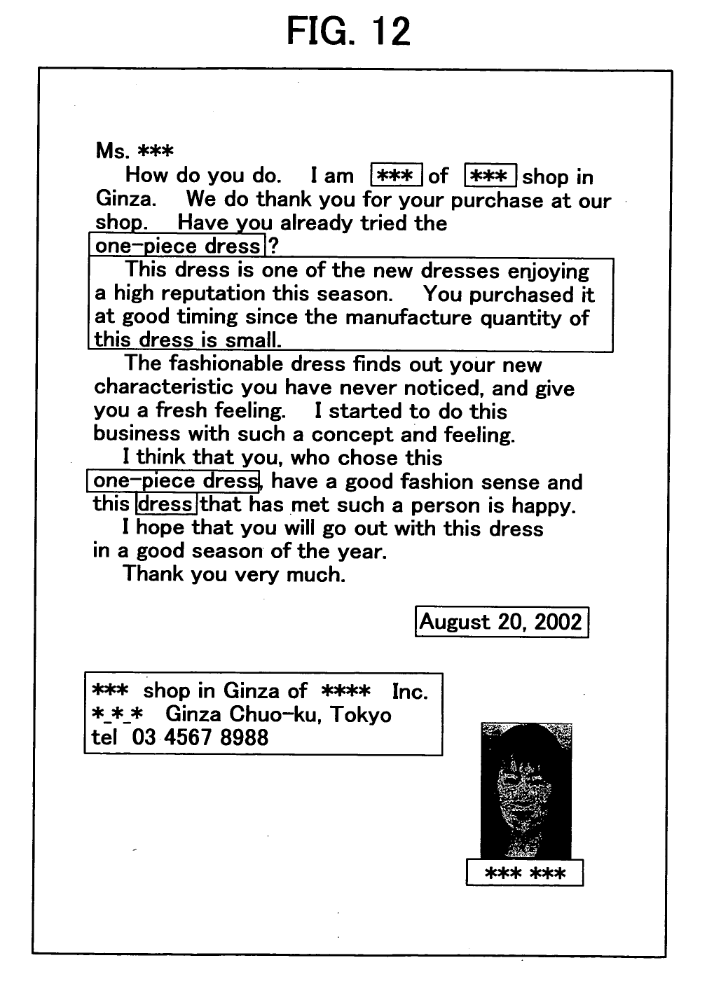

The contents setting screen includes a contents item section and a contents display section. FIG. 11 is a view illustrating one example of the contents item section, and FIG. 12 is a view illustrating one example of the contents display section. The contents item section includes a tool setting section and a variable item section.

The variable item section designates a variable item, which is an item that varies according to a preset condition. As example items, a name of customer, a name of salesperson in charge, a name of purchased commodity, purchase time/commodity, a seasonal greeting, a name of shop that performs issuing, a brand (shop) logo, a face photo and a name, an issuing date, a personal profile can be set. For example, the contents of the variable item section vary for each customer to which an action should be taken according to a preset rule. The main office terminal 12, the shop terminal 33, or the POS data storage 11 may prestore information indicating the rule, and the main office terminal 12 and the shop terminal 33 may automatically the contents of the variable item section such that information conforms to the rule. Or, the contents of the variable item section may be one that varies according to the operation from the operator.

The tool setting section includes two or more selection designation item columns and an item name is added to each of the selection designation item columns. In the example of FIG. 12, “tool used in transmitting a message”, “size type”, “background”, “character, font, and print color”, “layout designation”, “output location”, “action execution date”, “repeat execution”, “target”, and “evaluation index” are used. The operator of the main office terminal 12 or that of the shop terminal 33 enters a selection designation item corresponding to the item name to each selection designation item column to designate the contents specifically. For example, in the selection designation item whose item name is “tool”, a tool type name, for example, any one of“DM”, “e-mail” (PC type mail and cellular phone type mail, facsimile) and a sealed letter is entered. When the operator of the main office terminal 12 or that of the shop terminal 33 inputs that the entry to the selection designation item column is completed, the selection designation item entered to the selection designation item column is sent to the POS data storage 11 in response to this input. The POS data storage 11 stores the pertinent selection designation item. In addition, the selection designation item column may have a pull-down menu format. In this case, the operators of the main office terminal 12 and the shop terminal 33 may operate the main office terminal 12 and the shop terminal 33 such that any one of selection designation items described in the pull-down menu is designated in place of entering the selection designation item to the selection designation item column. The pull-down menu may be hierarchized to multiple hierarchies.

An explanation will next be given of a customer information screen that is displayed by the shop terminal 33. The customer information screen is a screen including information relating to the customer. The shop terminal 33 displays the customer information screen, thereby helping the salesperson of the shop 30 to refer to the customer information screen to deepen the relationship with the customer at the shop. More specifically, when the commodity is accessories, the salesperson makes a suggestion about a precise coordination to the customer to boost service to the customer.

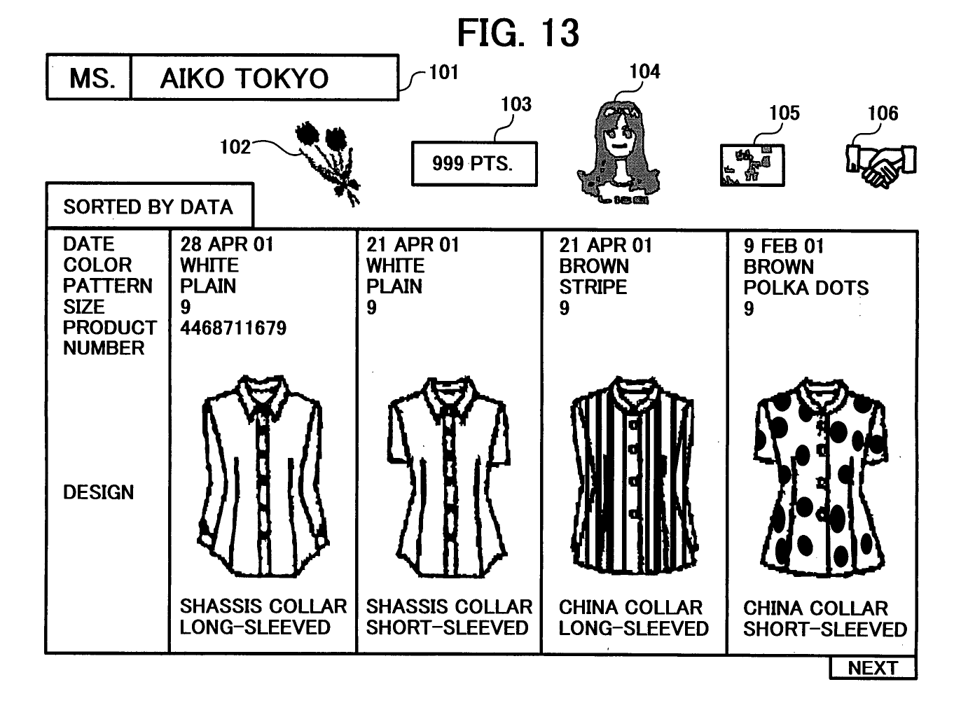

FIG. 13 is a view illustrating one example of the customer information screen displayed by the shop terminal 33. The shop terminal 33 specifies a customer, who has come to the shop, obtains customer information on the customer from the main office terminal 12 or the POS data storage 11, and displays the customer information screen including obtained customer information. Additionally, the shop terminal 33 may obtain customer information obtained by, for example, the card reader 31 and the barcode reader from the card reader 31 and the barcode reader, or specify a customer according to an operation from an operator who has memorized customer's looks. Moreover, the operator can use customer's looks, which the shop terminal 33 displays in the customer information sub-screen to be described later, as a clue to remember the customer.

The customer information screen of FIG. 13 includes a customer name display portion 101, a customer rank/purchase frequency display portion 102, an icon 104 such as a customer's portrait, face photo, and the like, a payment method display portion 105, an icon 106 for opening a relation history table, and a purchased commodity history display portion 107 as in the figure. When the client company introduces a point service, the customer information screen includes a point display portion 103 as in the figure.

In addition, the customer rank/purchase frequency display portion 102 of FIG. 13 shows a customer rank by a flower size and a purchase frequency by the number of flowers as illustrated in the figure. The display in this manner prevents a case in which the customer rank and the purchase frequency are inferred by a customer, who viewed the customer information screen. The same display idea as one that prevents a case in which the customer rank and the purchase frequency are inferred by a customer, who viewed the customer information screen may be performed to other structural portions of the customer information screen.

The purchased commodity history display portion 107 displays the history of the commodities purchased by the customer in any one of manners designated by the operation from the operator among multiple manners (for example, display along a time series, display for each season, display for each item, and the like). It is assumed that the purchased commodity history display portion 107 displays information on the commodity by, for example, listing about 15 commodities. Information on the commodity may be, for example, a commodity purchase date, a color, a pattern, a size, a product number, a design picture of the pertinent commodity and the like.

Moreover, in the purchased commodity history display portion 107, the shop terminal 33 may reverse display a purchase date display portion, which relates to multiple commodities that were purchased on the same day. Such display makes it possible for the salesperson to easily recognize that the customer purchased these items at the same time. Furthermore, in the purchased commodity history display portion 107, the shop terminal 33 may change a display color of a portion, which displays the purchase date, according to the commodity purchase date. For example, when the purchase date is in the past year, the color is white, when the purchase date is in the past one to two years, the color is thin gray, when the purchase date is in the past two to three years, the color is thick gray, and when the purchase date is over the past three years, the color is thicker gray.

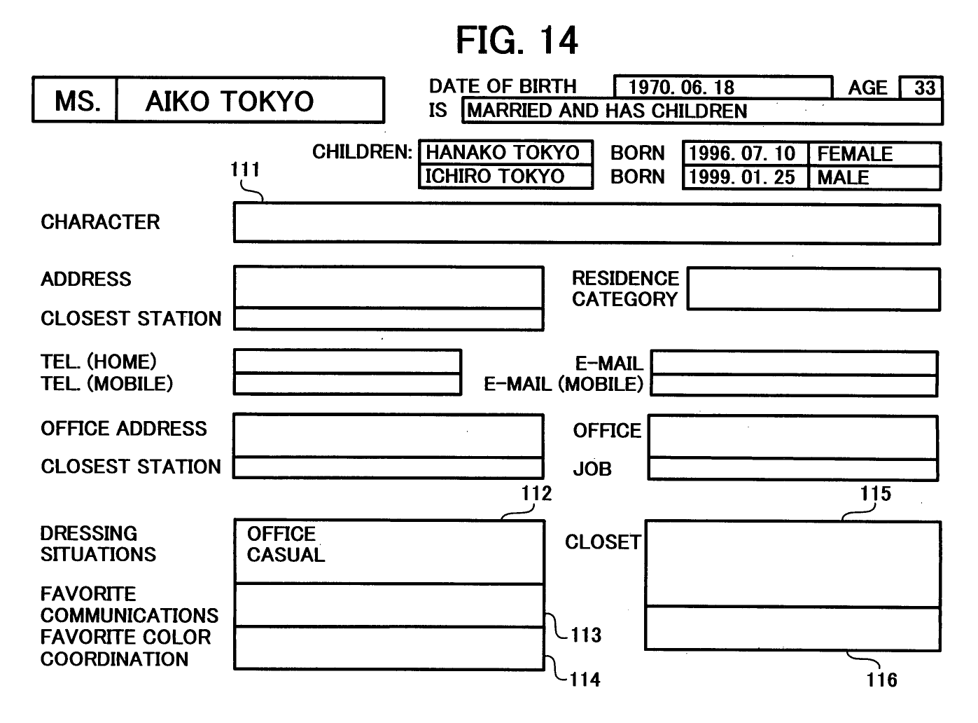

Moreover, the shop terminal 33 may display the customer information sub-screen. FIG. 14 is a view illustrating one example of the customer information sub-screen. At the shop, the client information sub-screen is a screen including attribute information. Attribute information may be, for example, a customer name, a birthday, a six, family information, an address, a telephone number, an office name, an office address, an occupation, an address division, a nearest station from home, an e-mail address, a nearest station from office, a holiday, and the like. In addition, attribute information may be obtained by, for example, the main office terminal 12, the POS register 32, and the shop terminal 33 according to the operation from the operator.

Attribute information may include a text that expresses a customer's attribute in order to express the customer's attribute in an analog.

Accordingly, as illustrated in FIG. 14, attribute information may include, for example, a text 111 describing looks and atmospheric features such as “a customer who resembles an entertainer Mr./Miss/Mrs. X and has rather small eyes and a prominent jaw and urban atmosphere.” Moreover, when the commodity is accessories, attribute information may include a text 112 describing the features of dresses by situation (office, casual, and the like). Further, attribute information may include materials 113 that are useful when the salesperson performs communication with the customer, such as a customer's favorable color, a customer's favorable tastes and looks, a lively pleasant conversation between the salesperson and the customer, customer's hobbies, pets that the customer purchased, and the like. Furthermore, customer attribute information may include a text 114 describing the features of customer's coordination (combination and arrangement of two-piece dress, color selection, and the like). Moreover, attribute information may include customer's closet information (information on shoe size, small articles, underwear and the like) 115. Furthermore, attribute information may include information 116 indicating a customer's favorable shop excepting the shop 30.

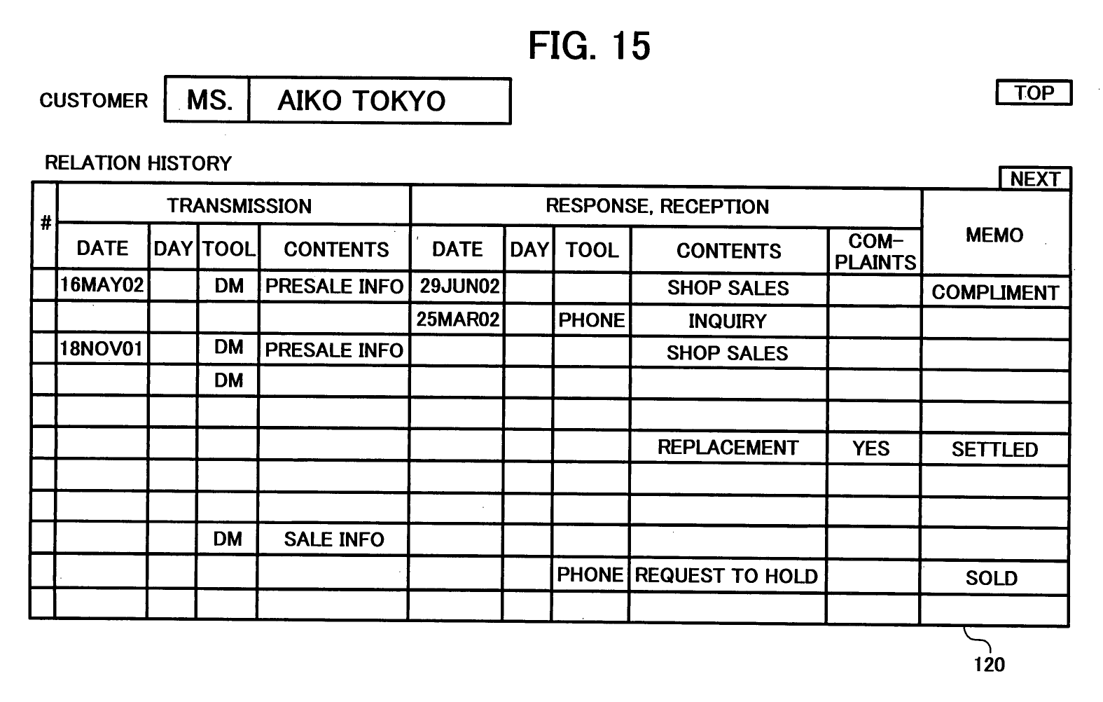

When the operator operates the shop terminal 33 to click the icon 106, the shop terminal 33 displays a relation history table 120 as illustrated in FIG. 15 in response to the click. The relation history table 120 is a table showing a history of communications between the customer and the client company by customer. The contents of the history of communications include, for example, transmission year, month and day, and a day of the week, a tool (DM, telephone, and the like) used in transmission, the contents of message as a transmission history of the message from the client company side. Moreover, response year, month and day, and a day of the week, and a tool used in response, and the contents of the customer's message and complaint are included as a history of response to a customer's message. A memo with arbitrary contents may be added to the communication history. In addition, the shop terminal 33 may read data indicating e-mail, facsimile, or DM, which was transmitted and printed by the shop terminal 33 itself or the main office terminal 12, and obtain the contents of the telephone with the customer according to the operation from the operator, thereby gaining information indicating the communication history.

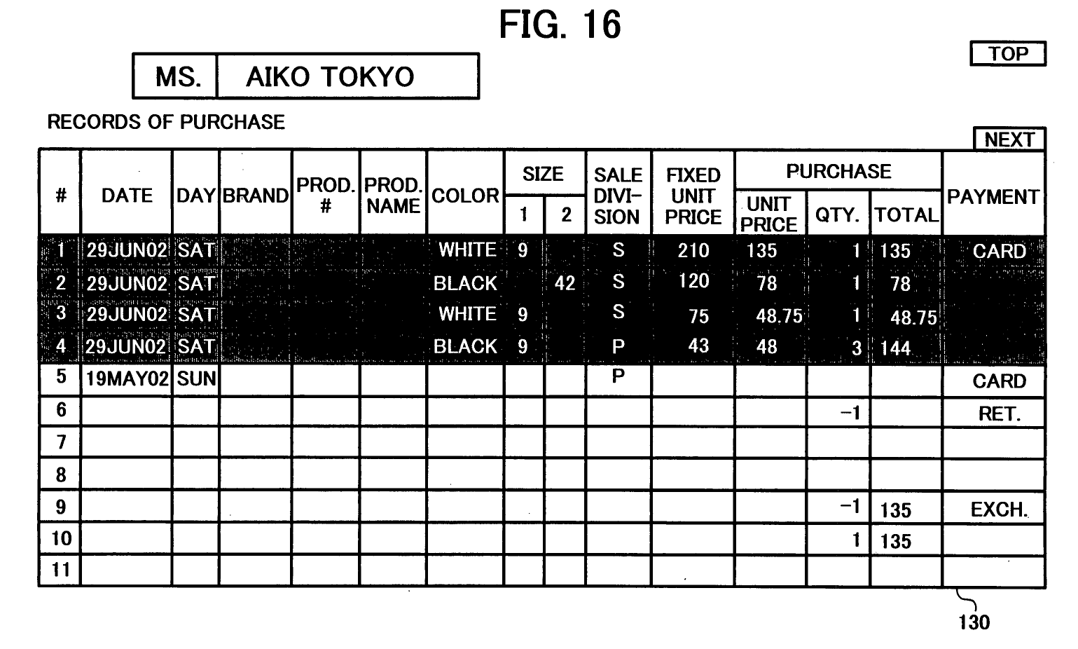

The shop terminal 33 may display, for example, a purchase history screen as illustrated in FIG. 16. The purchase history screen can display purchase history information 130 for each customer. Purchase history information may include, for example, purchase year, month and day, and a day of the week, a manufacturer name of purchased commodity, a product number, a color, a size, sales division, a fixed unit price, purchase amounts (unit price, quantity, total amounts of money), an a payment method, and the like. Furthermore, in purchase history information 130, the shop terminal 33 may reverse display a purchase date display portion, which relates to multiple commodities that were purchased on the same day.

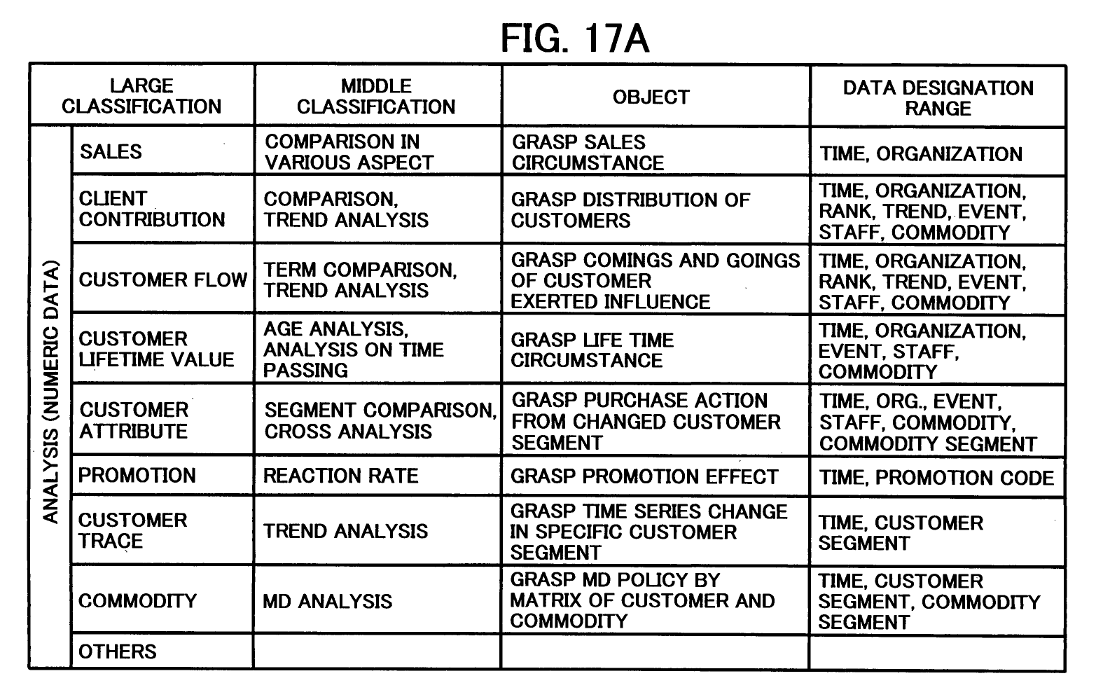

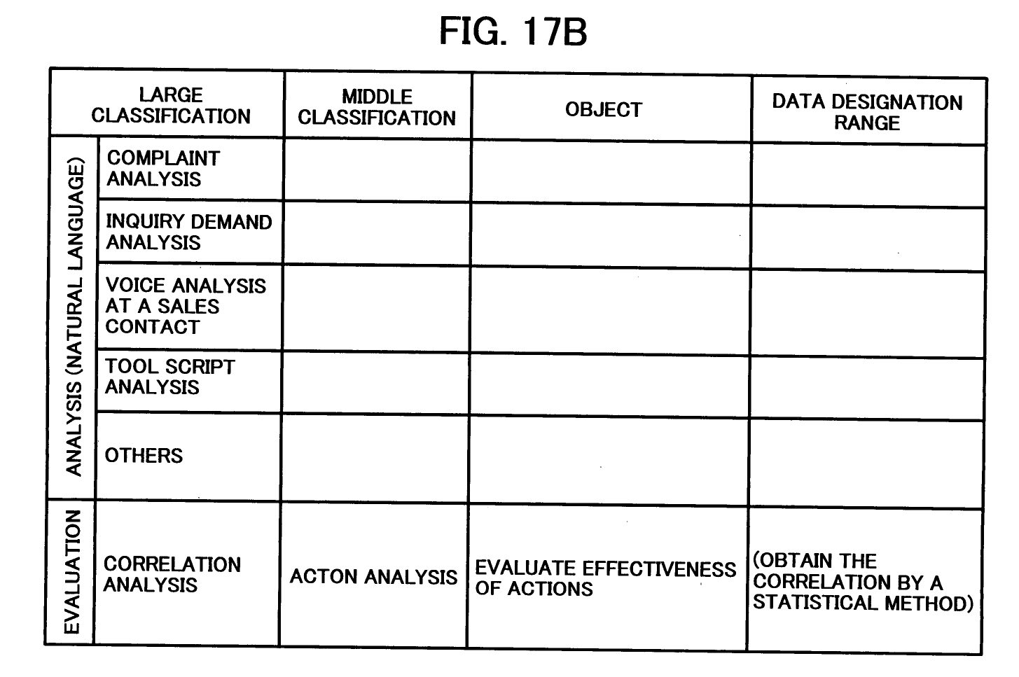

Next, an explanation will next be given of an analytical system step. FIGS. 17A and 17B are views explaining a customer analyzing method that can be executed in an analytical system step in a business scheme that is implemented by the one-to-one business system. As illustrated in the figure, in the analytical system step, a sales analysis, a customer contribution analysis (corrected decile analysis), a customer flow analysis, a customer life time value analysis (LTV analysis), a customer attribute analysis, a promotion analysis, a customer trace analysis, commodity analysis, and the like can be applied as numerical data analytical system processing. Moreover, a complaint analysis, an inquiry demand analysis, a voice analysis at a sales shop, a voice analysis at a sales contact, a tool script analysis, and the like can be applied as natural language analytical system processing. Furthermore, a correlation analysis can be applied as evaluation system processing.

Among these, the sales analysis is an analytical method that aims to grasp a sales circumstance of the client company itself, and executes comparison in plan, comparison in time, and comparison in other company analysis to designate data used in the analysis by time (time designation, time and date/week/month/quarter/year), by organization department, by event, by salesperson, and by commodity classification.

Moreover, the customer contribution analysis (corrected decile analysis) and the customer flow analysis aim to grasp the comings and goings of customers exerted an influence on the sales and/or perform a time comparison analysis and a trend analysis. In the customer contribution analysis, a rank-specific flow (withdrawal/new/rank-up/rank-down) in time comparison and a change in mid-term trend are analyzed in addition to data analysis that is performed by various types including time designation, organization department, event, salesperson, commodity classification.

The customer life time analysis aims to grasp a customer's life time circumstance and performs a customer age analysis and an analysis on time passing since an actual purchase date. In the customer life time analysis, data used in the analysis is designated for each of various time types, department, event, salesperson or commodity classification, and each analysis is thereby performed similar to the sales analysis.

The customer attribute analysis aims to grasp a purchase action from a changed customer segment and performs a segment comparison analysis and a commodity cross analysis. In the customer attribute analysis, data used in the analysis is designated for each of various time types, department, event, salesperson or commodity classification, size, purchase date, or purchased commodity, and each analysis is thereby performed. The promotion analysis aims to grasp a promotion effect, and performs a customer reaction rate analysis. In the promotion analysis, data used in the analysis is designated for each of various time types and promotion code (action number) to perform each analysis.

The customer trace analysis aims to grasp a time series change in a specific customer segment and performs a trend analysis. In the customer trace analysis, data used in the analysis is designated for each of various time types as in the above or customer segment to perform each analysis. Moreover, the correlation analysis of the evaluation system aims to evaluate validity of the action number, and is an analytical method for obtaining the correlation among various types of parameters by a statistical method.

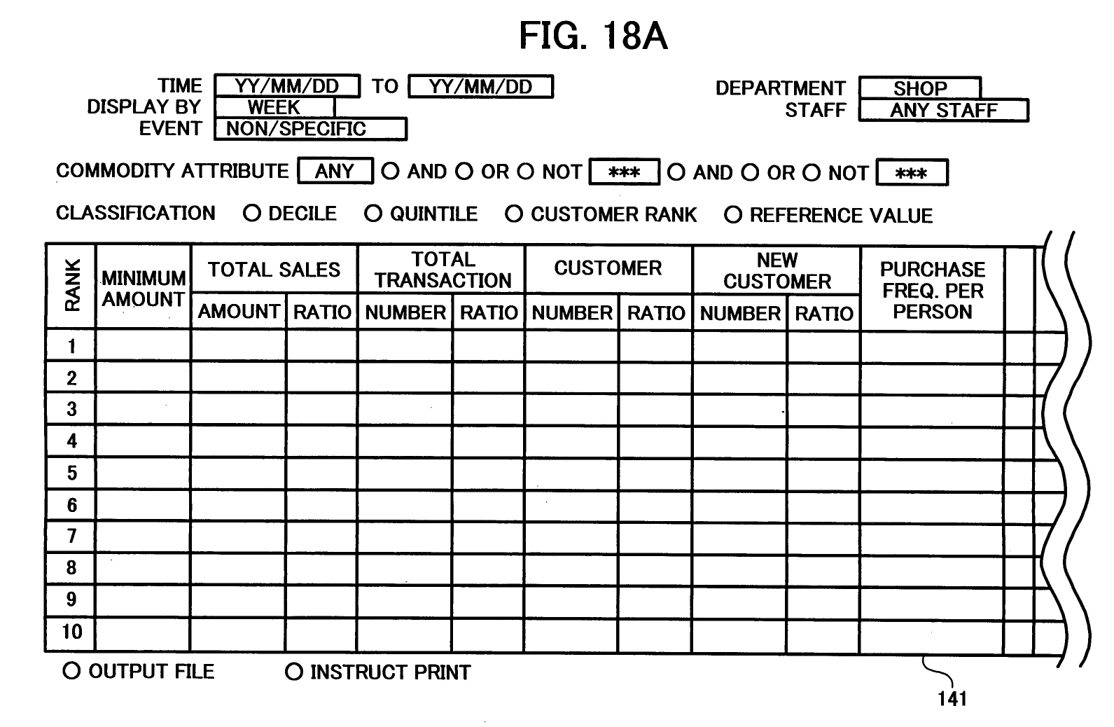

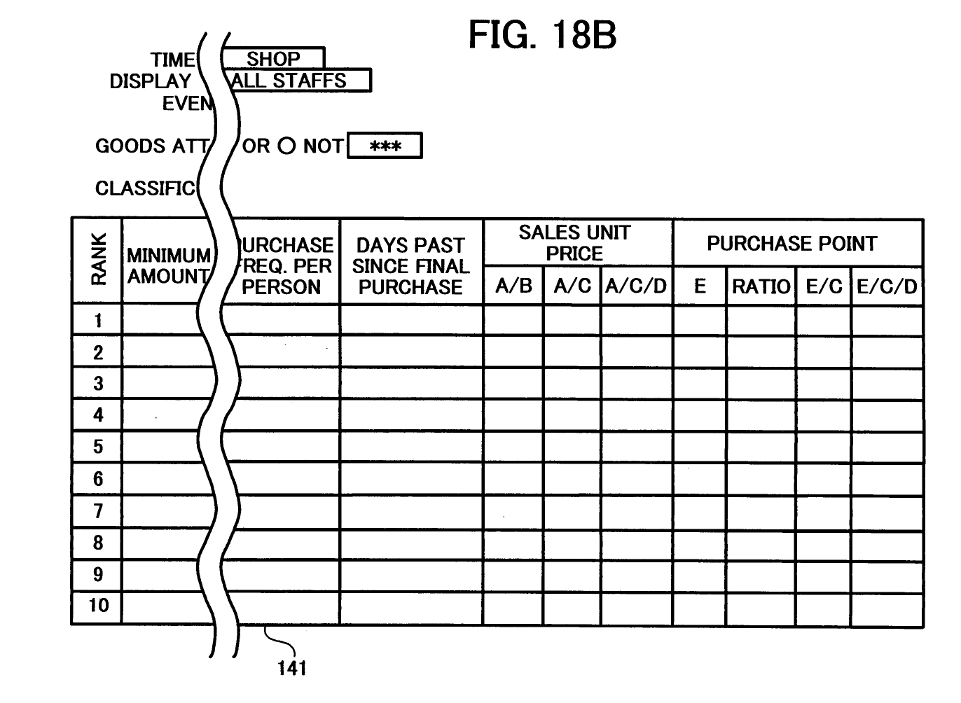

The one-to-one business support system specifically performs processing for displaying a sales contribution analytical report (customer analytical report) 141, for example, as illustrated in FIGS. 18A and 18B. In order to create data to be displayed in the sales contribution analytical report 141, the main office terminal 12 or the shop terminal 33 performs a customer rank division based on a parameter of a predetermined range to obtain various types of numeral values for each rank. The sales contribution analytical report 141 is formed of a screen in which the obtained numeral values are displayed for each rank.

The customer rank division may be performed in decreasing order (front-back) of parameter that is designated by the operator among the parameters (purchase characteristics) for a rank division that include, for example, (1) gross sales, (2) frequency of business transaction, (3) sales amount per one business transaction, (4) the number of commodities purchased per one business transaction, (5) unit price per one, or (6) date of day when most recent business transaction was performed. In addition, the main office terminal 12 and the shop terminal 33 may display, for example, an analytical report designation screen 140 to provide GUI to the operator, thereby receiving a parameter designation done by the operator.

Furthermore, a criterion that decides a boundary between two adjacent ranks may be arbitrarily set. Accordingly, for example, the criterion may be fixed by performing a decile division (10-equal division) and a quintile division (5-equal division) in decreasing order of parameter that is designated by the operator. Moreover, all customers, each having a different parameter value, may be divided into different ranks. Or, a criterion value that is designated by the customer may be a boundary.

Moreover, in connection with the customer belonging to the pertinent rank, the numerical values about one rank may be, for example, a total sales amount (A) from the pertinent customer, the total number of customers (B), the number of customers (C), the number of new customers among the number of customers (the number included in the number of customers C), a purchase frequency (D) per one customer, average days passed since the final purchase date, an average of purchase unit price (average unit price per one customer (A/B)), an average unit price (A/C) per one customer and unit time, an average unit price (A/C/D) per one person and one business transaction, the number of purchases (a cumulative total (E) of purchase quantities within a predetermined time), the number of average purchases (E/C) per one customer and unit time, the number of average purchases (E/C/D) per one customer and one business transaction, and a numeral value of a parameter for rank division in the lower limit of the pertinent rank. Furthermore, the main office terminal 12 and the shop terminal 33 may search a customer name belonging to the pertinent rank from the POS data storage 11 in response to the pertinent designation and list and display it.

Furthermore, the main office terminal 12 and the shop terminal 33 may limit target data used to obtain a numeral value for each rank to data, which satisfies a condition designated by the operator, to obtain the aforementioned numeral value. Any condition may be possible if the condition depends on, for example, time, a type of business transaction (for example, whether it is a specific event, and the like), a shop where a business transaction was made, a sales floor where a business transaction was made, an area where a business transaction was made, or a salesperson who was concerned with a business transaction.

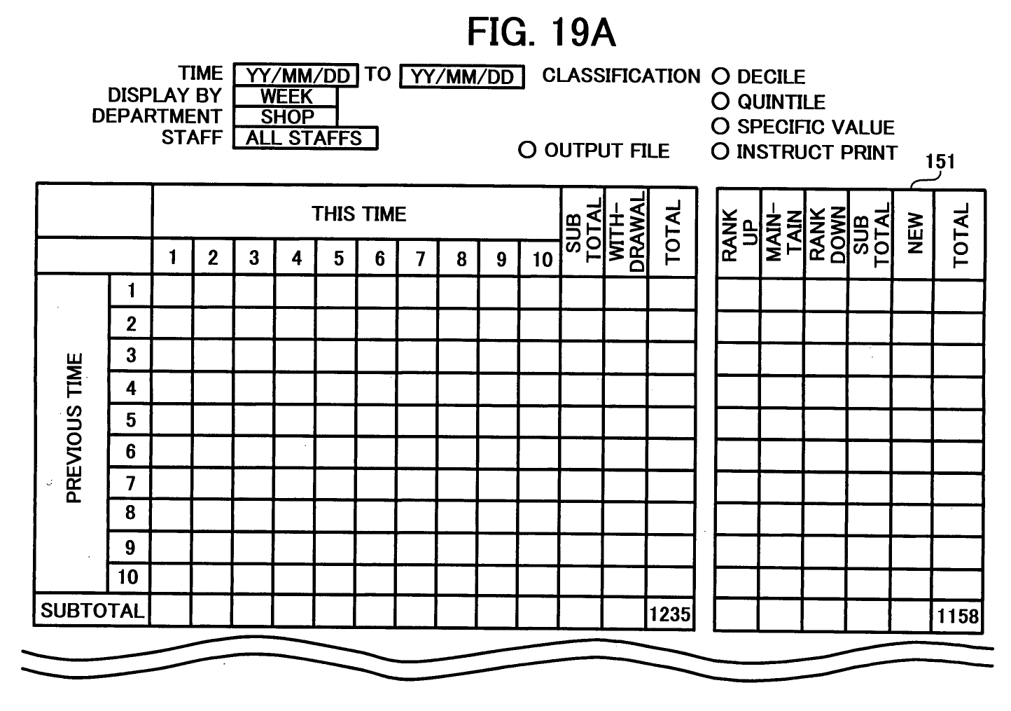

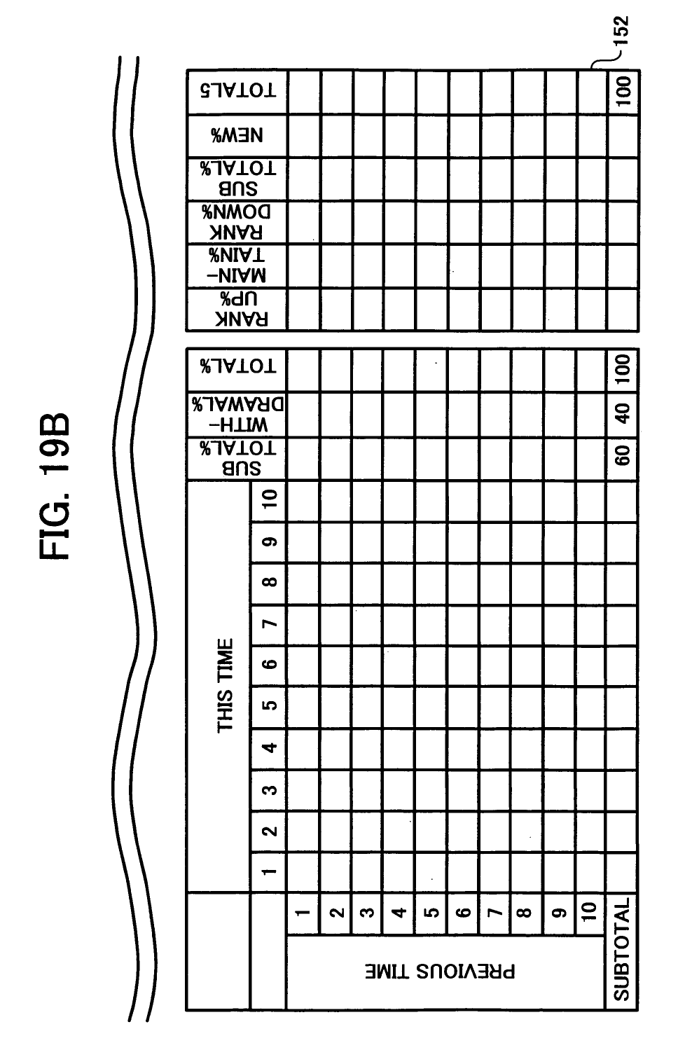

Furthermore, the one-to-one business support system performs processing for displaying a screen as illustrated in, for example, FIGS. 19A and 19B as processing relating to the customer flow analysis. The client company can use information included in this screen at the time of performing the customer flow analysis. In order to create data to be displayed in this screen, based on the result of the customer rank division in the customer contribution analysis performed two times, the main office terminal 12 or the shop terminal 33 classifies the respective customers in a two-dimensional matrix manner according to the rank to which the customers belonged at the first time and the rank to which the customers belonged at the second time. The main office terminal 12 or the shop terminal 33 obtains the number of customers belonging to the respective elements of this matrix, and a ratio of the number of customers belonging to the respective elements to the total number of customers. The screen shown in FIGS. 19A and 19B is formed of the screen that displays the obtained number of customers of each element and the ratio. In the screen shown in FIGS. 19A and 19B, the number of customers belonging to the respective elements of this matrix is displayed in a display portion 151 and the ratio of the number of customers belonging to the respective elements to the total number of customers is displayed in a display portion 152.

Additionally, the main office terminal 12 and the shop terminal 33 may limit the customers as an object to obtain the number of customers for each element and the ratio to the customers, who satisfy a condition designated by the operator. Any condition may be possible if the condition depends on, for example, a business transaction time, a type of business transaction, a shop where a business transaction was made, a sales floor where a business transaction was made, an area where a business transaction was made, or a salesperson who was concerned with a business transaction. Then, the main office terminal 12 and the shop terminal 33 may display, for example, an object data designation screen 150 shown in FIGS. 19A and 19B to provide GUI to the operator, thereby receiving a parameter designation done by the operator. Furthermore, when the operator designates a specific element of the matrix, the main office terminal 12 and the shop terminal 33 may search a customer name belonging to the pertinent element from the POS data storage 11 in response to the pertinent designation and list and display a customer trace screen (to be described later) in connection with the searched customer.

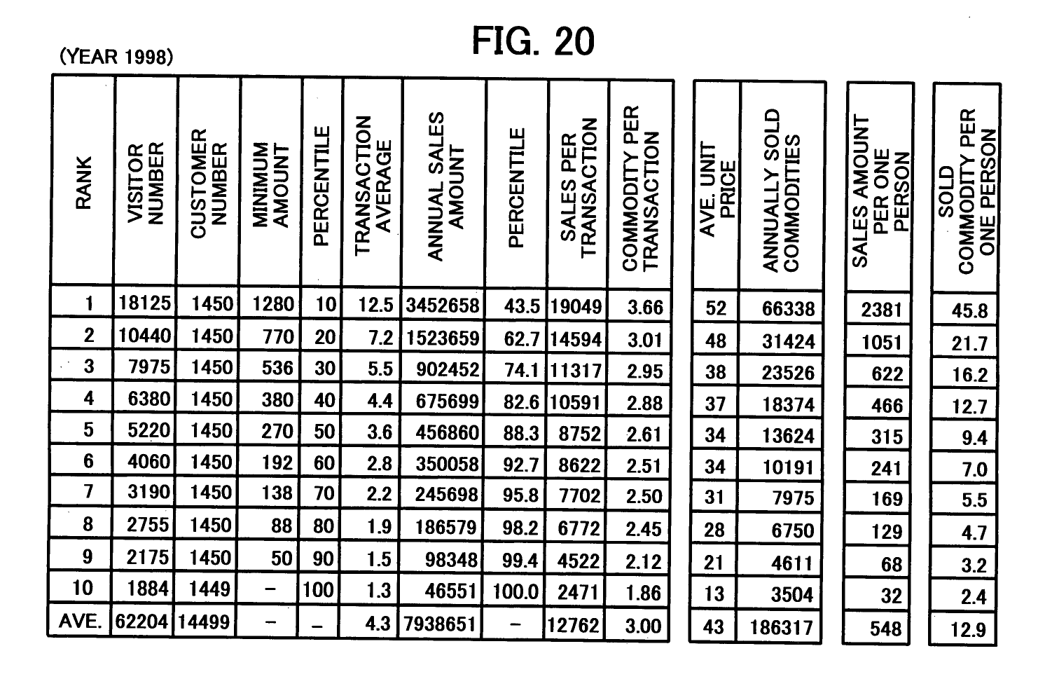

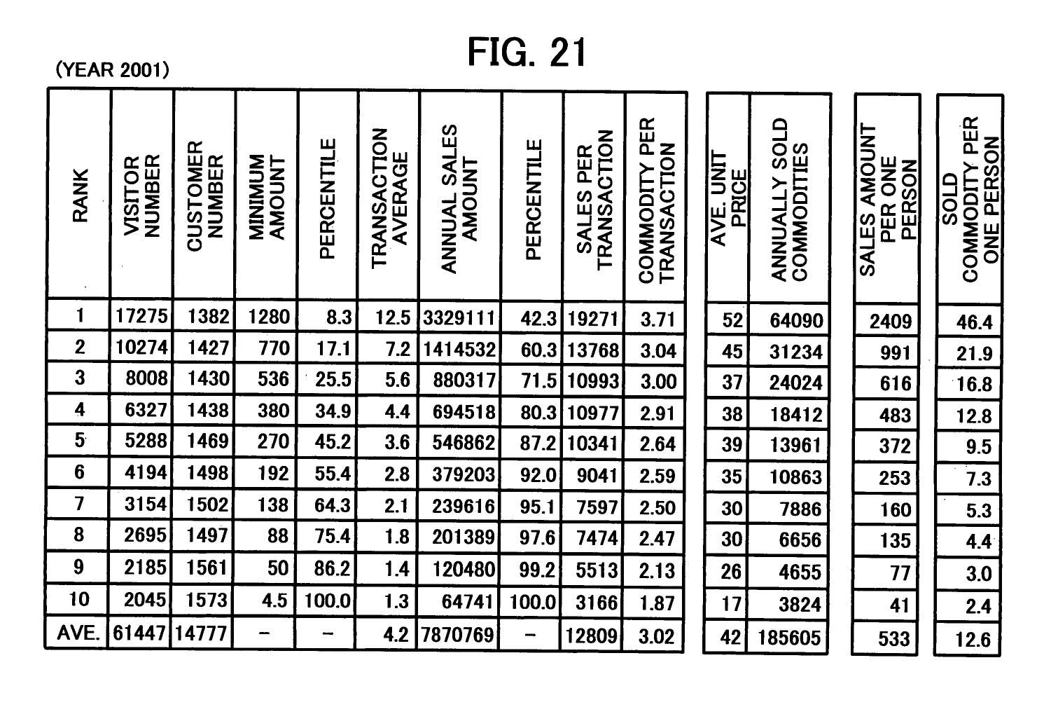

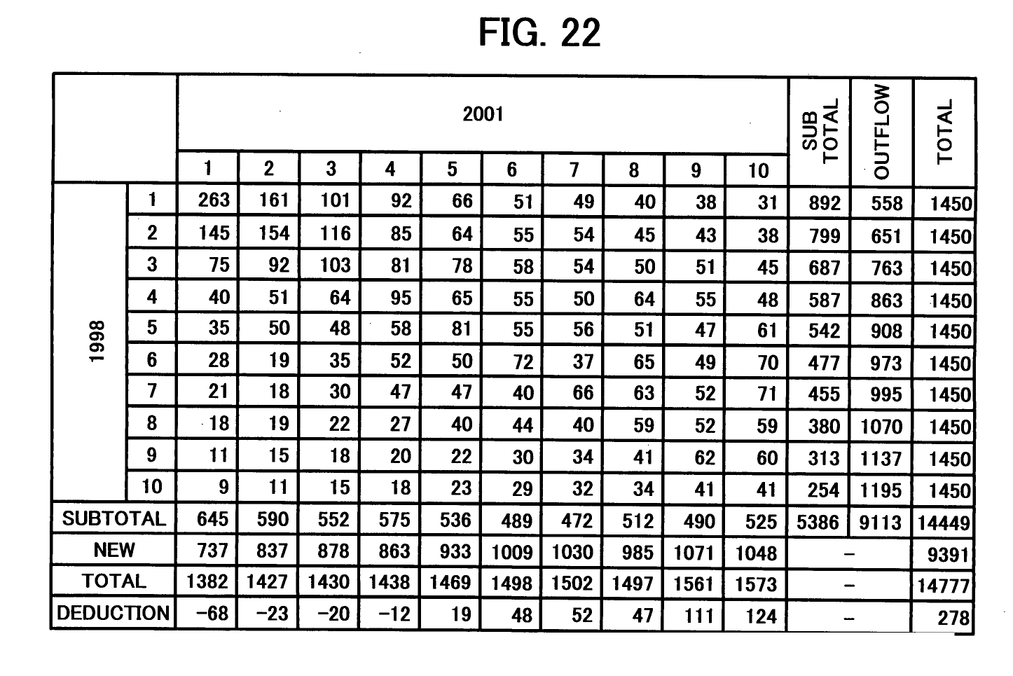

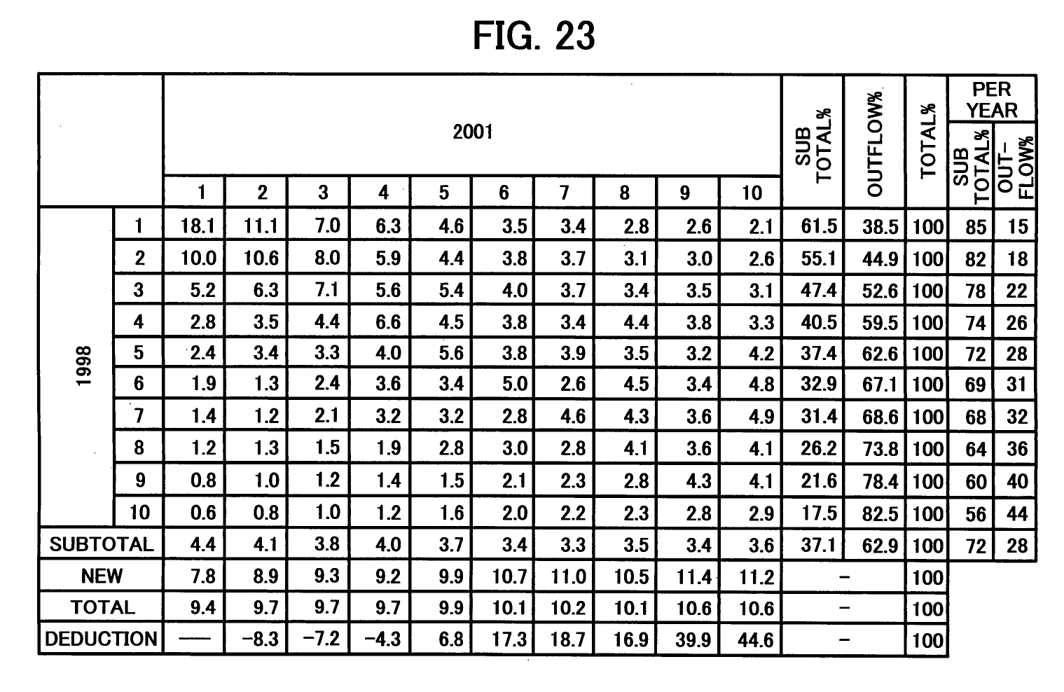

FIGS. 20 to 23 are views illustrating specific examples of the customer contribution analysis, and the customer flow analysis, respectively. FIG. 20 is a view illustrating an example in which the number of customers of a single year is rank-divided according to the sales amount per one customer as a customer contribution analysis. FIG. 21 is a view illustrating a result of a customer contribution analysis in which the number of customers is rank-divided on the same criterion as the criterion of FIG. 20 three years later after the customer contribution analysis shown in FIG. 20. FIGS. 22 and 23 are views each illustrating a result of a customer flow analysis performed based on the result of the customer contribution analyses shown in FIGS. 20 and 21. FIG. 22 is a view illustrating the number of customers belonging to the respective elements of the matrix, and FIG. 23 is a view illustrating the ratio of the number of customers belonging to the respective elements to the total number of customers. The main office terminal 12 and the shop terminal 33 execute an application supplied from the web server 23a or a program stored by each terminal based on information stored by each terminal or the POS data storage 11, thereby creating data indicative of images shown in FIGS. 20 to 23 based on data stored by the main office terminal 12 and the shop terminal 33 or the POS data storage 11 to display these images.

Additionally, regarding the element that satisfies a predetermined condition such as a case in which the numeral value exceeds an average value, the main office terminal 12 and the shop terminal 33 may display the pertinent portion in a different manner from the other element value. More specifically, the pertinent value may be displayed in a different typeface, or in boldface type, or with a background color different from others.

The client company can know the trends of the new customer acquisition and customer withdrawal based on the analytical result as illustrated in FIGS. 20 to 23. For example, of all customers of those days who were subjected to the client contribution analysis in FIG. 20, the client company can know that the number of persons, who remain as customers, is only 37%, and 28% of customers withdraw per year in three years later with reference to FIGS. 22 and 23. Moreover, it is shown that the customers belonging to the low rank tend to have a high withdrawal rate, and 44% of the customers belonging to the lowest rank withdraw. On the other hand, it is shown that the withdrawal rate tends to be decreased as the rank of the customer becomes high. However, it is shown that 15% of the customers withdraw even in the case of the customers belonging to the highest rank. Moreover, it is shown that the customers, who the client company newly obtains, tend to belong to the low rank. It is also shown that the customers belonging to the high rank are not newly increased in number though they are little estranged, with the result that the total number of customers is not largely increased. Then, the client company can perform the targeting of customers with consideration given to these trends.

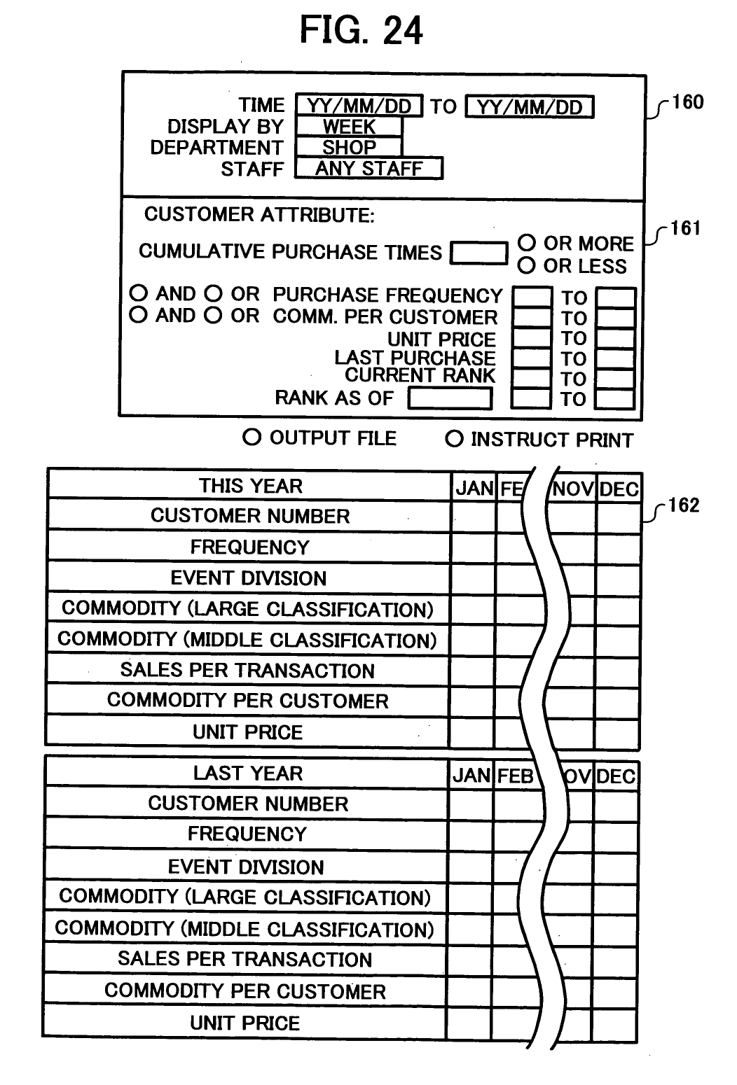

FIG. 24 is a view illustrating one example of a customer trace analytical screen. An operator can designate target data to be used in a customer trace analysis using a target data designation screen 160. An attribute of a customer to be used in the customer trace analysis can be designated using a customer attribute designation screen 161. As the pertinent data, for example, the number of cumulative purchase times, a purchase frequency, a point per one customer, a unit price per one, final purchase date, a current customer rank, a customer rank at a past designated point in time can be considered.

A customer trace analytical report in FIG. 24 is one in which data items of the number of customers, a purchase frequency, an event division, a commodity classification (large and meddle), a unit price per one customer, a point per one customer, unit price per one, are displayed in the form of a set of cells every month. The client company refers to such the customer trace analytical report to confirm a purchase pattern of a customer group extracted under a fixed condition, allowing a customer extraction, which plans an actual action plan, based on the purchase pattern. In addition, when an operator designates an arbitrary cell in a state that the customer trace analytical report is displayed, the main office terminal 12 and the shop terminal 33 may display a screen (to be described later) for performing outbound transmission setting in response to this designation.

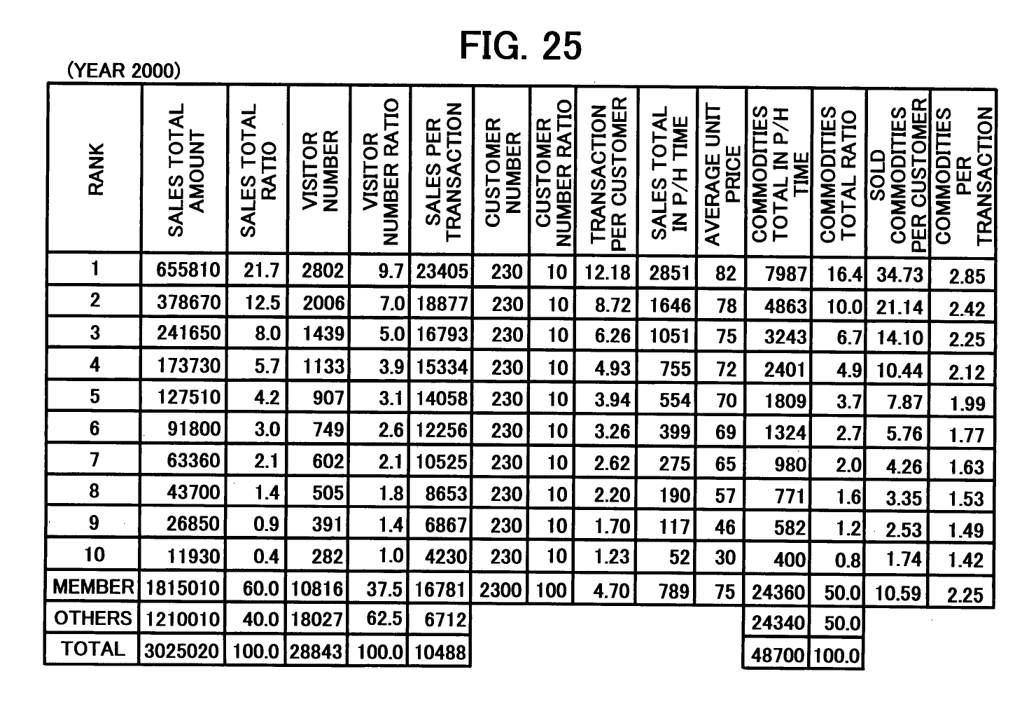

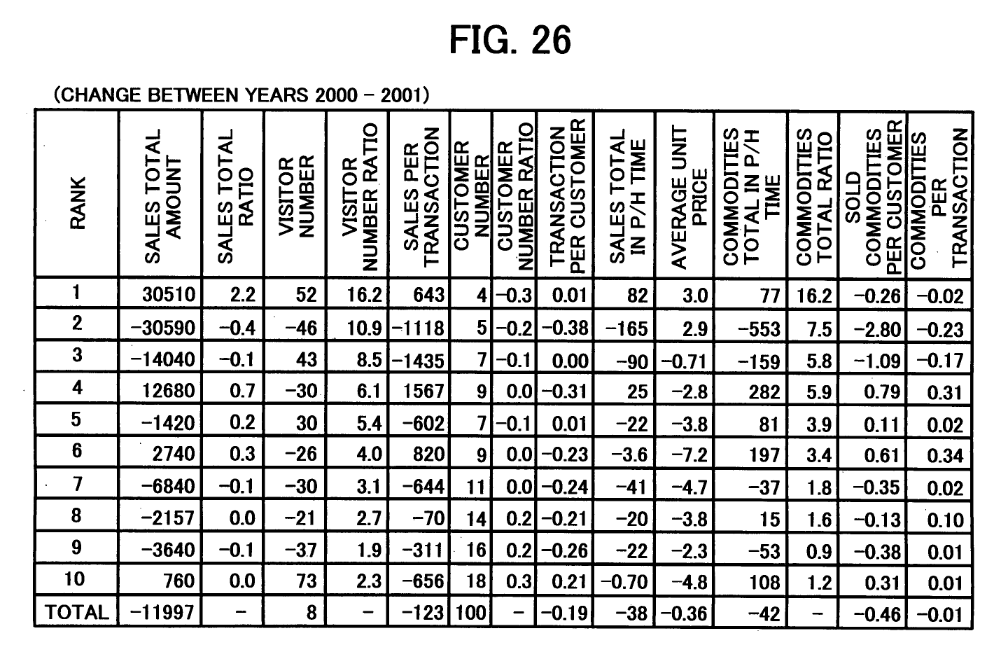

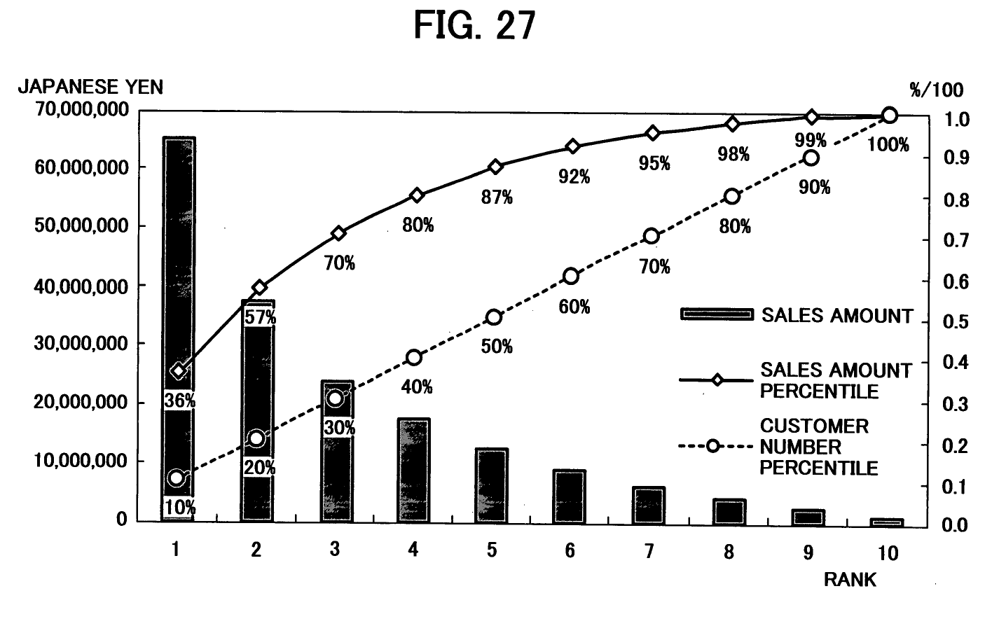

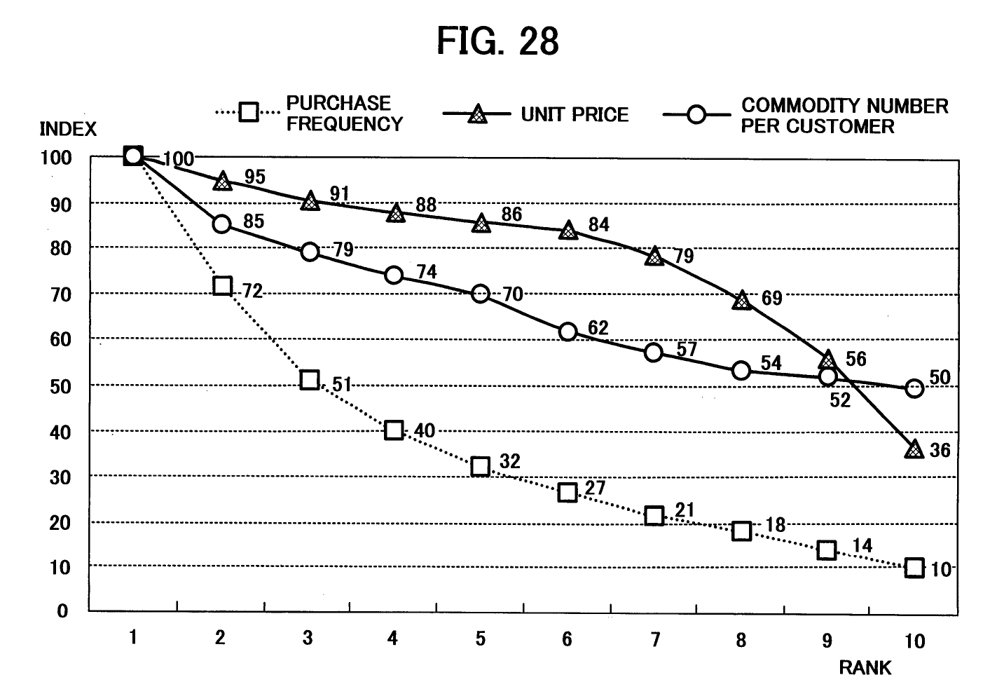

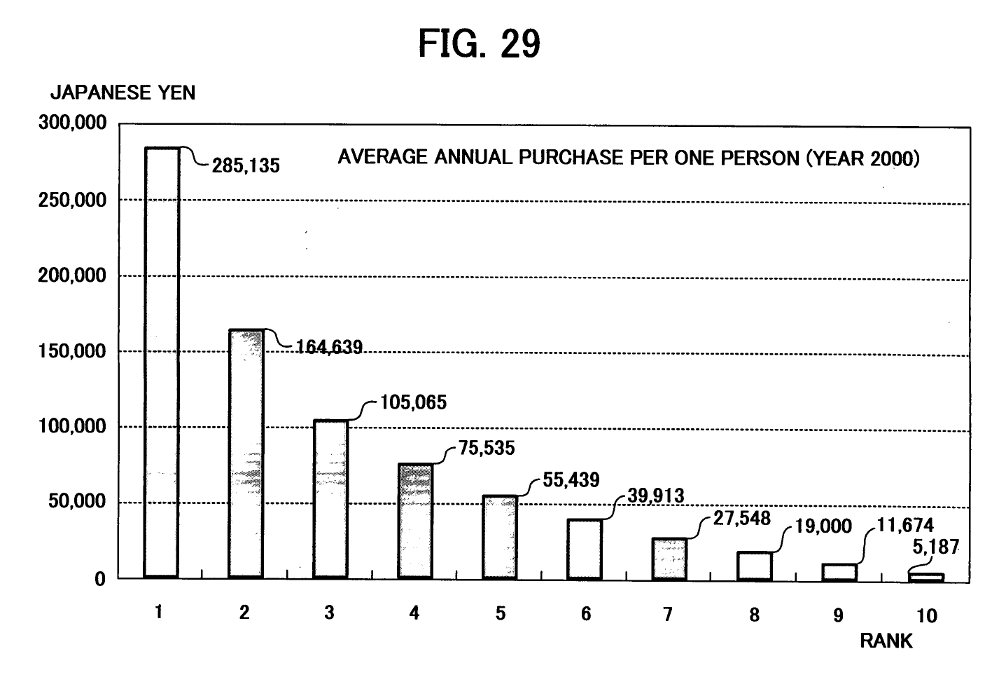

FIGS. 25 to 29 are views each illustrating another example of the customer flow analysis. FIG. 25 is a view showing a result obtained by rank dividing the number of customers of a single year according to the sales amount per one customer to perform the customer contribution analysis (corrected decile analysis). FIG. 26 is a view showing an amount of change between a result of the customer contribution analysis obtained by rank dividing the number of customers on the same criterion as the criterion of FIG. 25 one year later after the customer contribution analysis shown in FIG. 25 and the result of the customer contribution analysis shown in FIG. 25 (a black triangle in FIG. 26 is a mark indicating that the following numeral value is a negative value.) FIG. 27 is a Pareto diagram showing a degree of which the customer belonging to each rank contributes to the sales amount. In Pareto diagram of FIG. 27, a graph, which shows a result obtained by totalizing the number of customers from the lower rank in order, is superimposed. FIG. 28 is a graph showing the relationship among a rank, a purchase frequency per one customer belonging to the pertinent rank, an average unit price of the sales commodity, and the number of sales commodities per one business transaction. FIG. 29 is a graph showing the relationship between a rank and a purchase amount of money per one customer of each group of customers belonging to the pertinent rank for one year. The main office terminal 12 and the shop terminal 33 execute an application supplied from the web server 23a or a program stored by each terminal based on information stored by each terminal or the POS data storage 11, thereby creating data indicative of images shown in FIGS. 25 to 29 based on data stored by the main office terminal 12 and the shop terminal 33 or the POS data storage 11 to display these images.

For example, referring to FIG. 29, it is shown that the annual purchase amount reaches close to 300,000 Yen. It is also shown that the sales obtained from the top 30% of the customers amounts to 70% of the total amount of sales. Since the amount of sales can be considered based on an expression of the number of customers×purchase frequency per one customer×unit price of commodity×the number of purchased commodities per one business transaction, it can be understood that the sales frequency has an influence on the sales. Moreover, in the multiple customer contribution analyses performed at the multiple points in time, the criterion for rank division is unified in order to prevent a case in which the boundary between the ranks is different at the multiple points in time, thereby making it possible to know variation per hour in various kinds of numeral values relating to the business transaction with the customer.

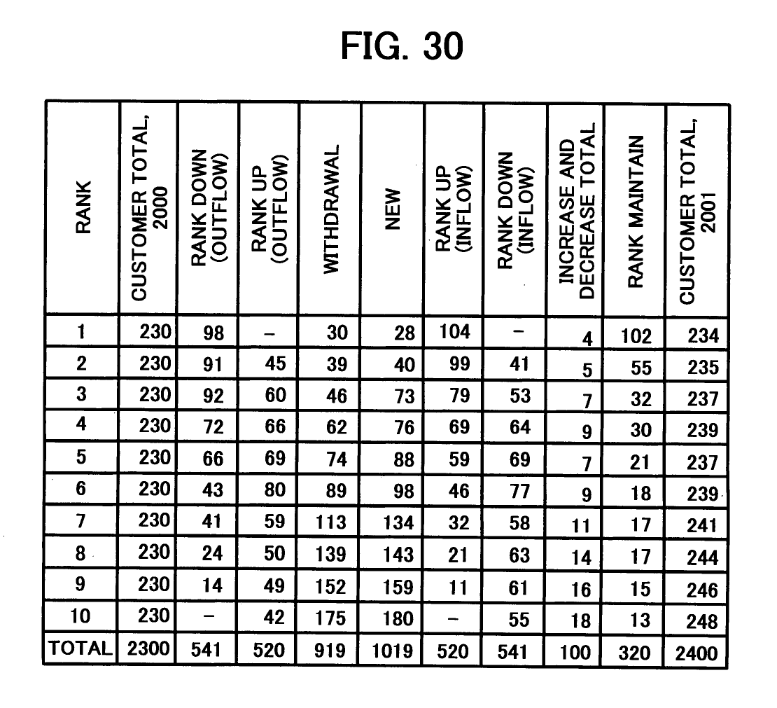

FIGS. 30 to 36 are views each explaining further another example of the customer flow analysis, and each showing a method for analyzing variation in customer rank. The customer flow analysis makes it possible to grasp the circumstances of the increase/decrease in the number of customers.

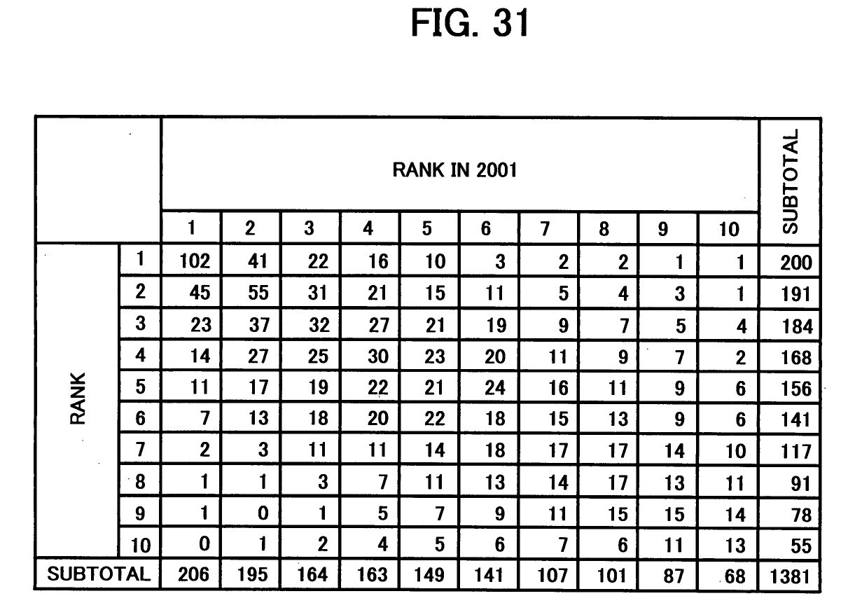

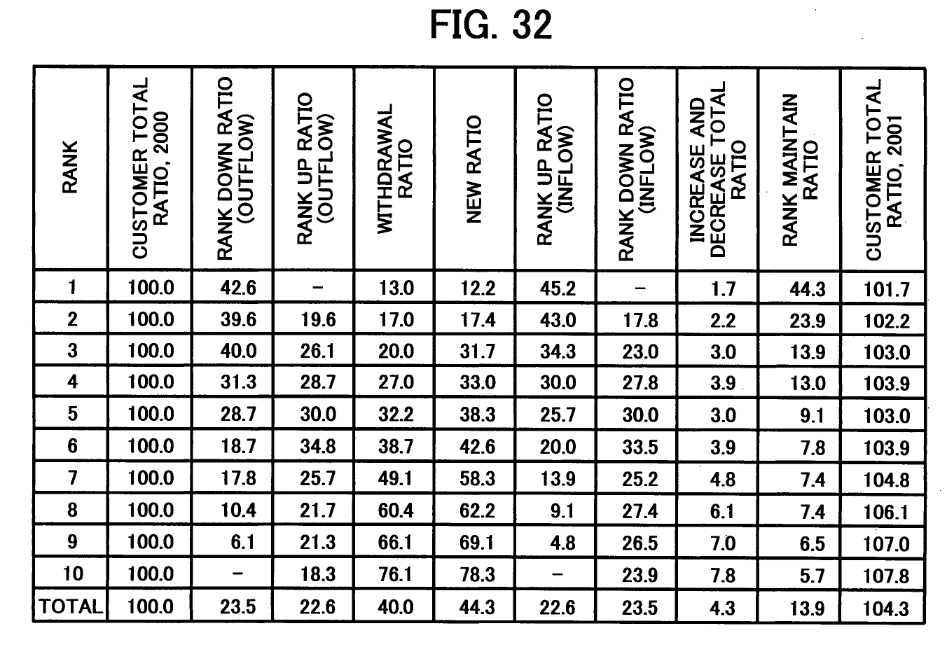

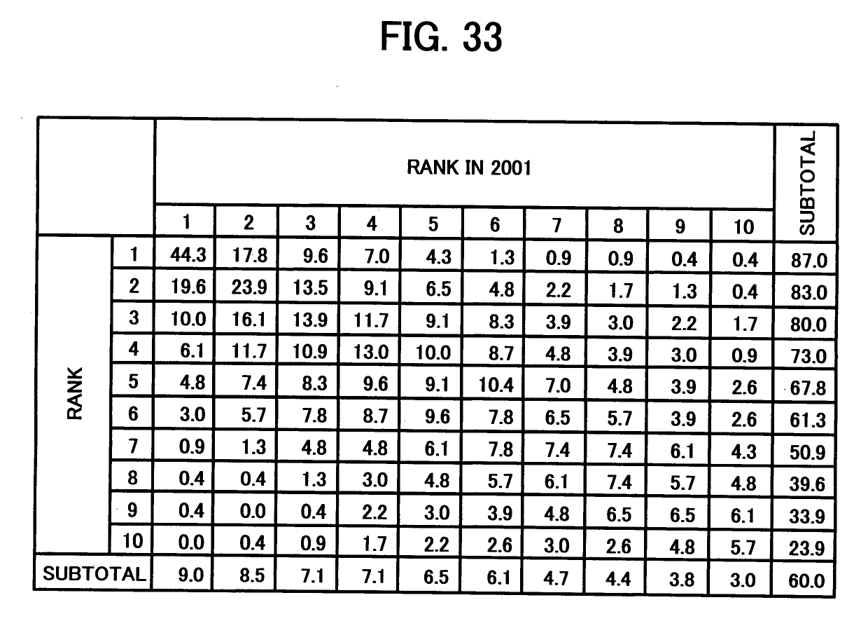

FIG. 30 is a view showing an increase and decrease and a breakdown of the increase and decrease by cause during 2000 to 2001 in connection with the number of customers belonging to the respective ranks. FIG. 31 is a view showing how many customers, who belonged to the respective ranks in 2000, moved and to which rank such customers moved in 2001. FIG. 32 is a view showing a percentage of an increase and decrease in the form of a breakdown of the increase and decrease by cause during 2000 to 2001 in connection with the number of customers belonging to the respective ranks. FIG. 33 is a view showing how many customers, who belonged to the respective ranks in 2000, moved and to which rank such customers moved in 2001 by a percentage by moving destination.

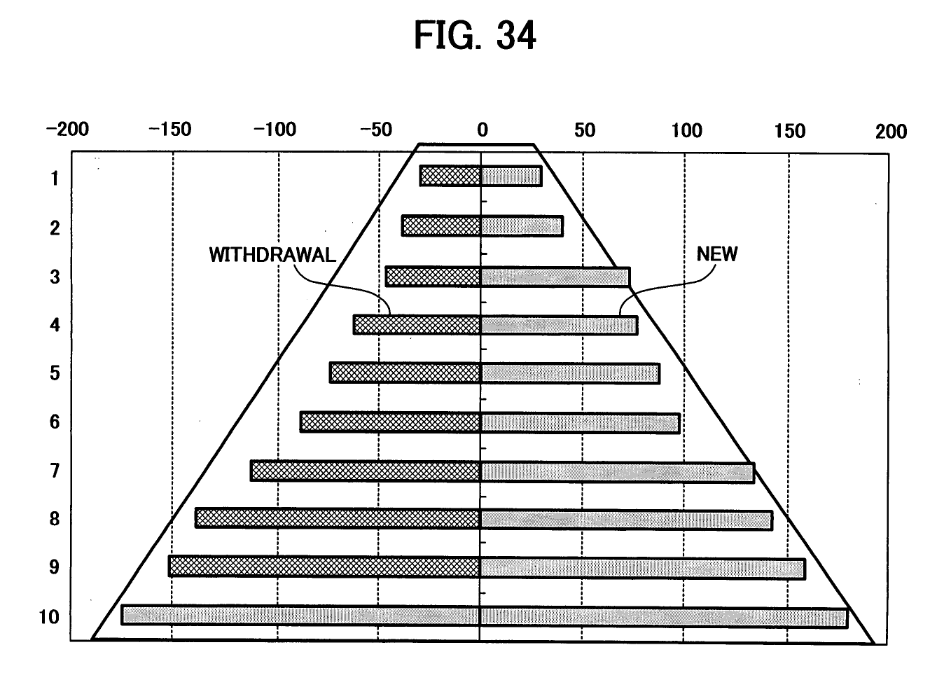

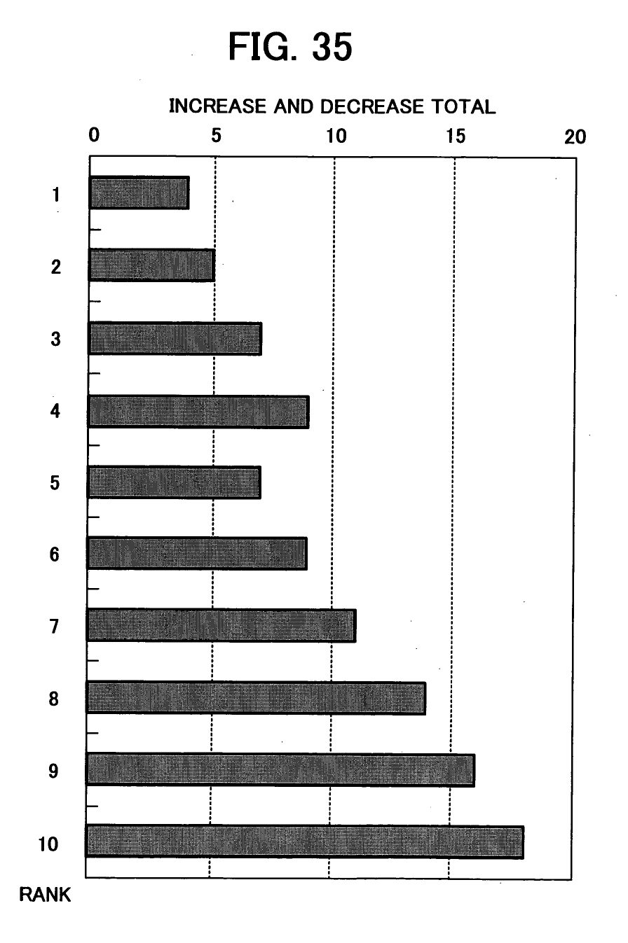

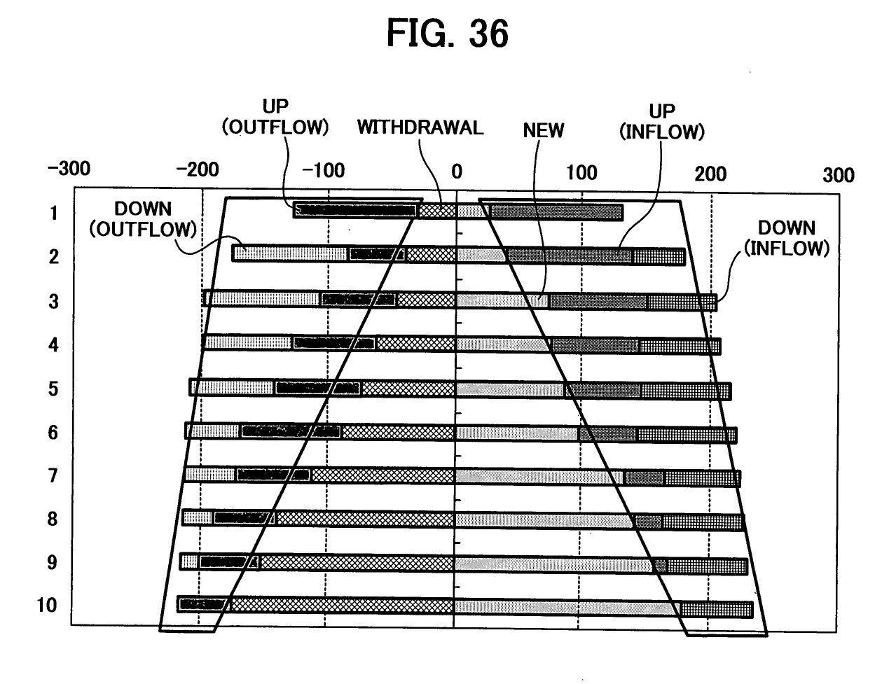

FIGS. 34 to 36 are views each showing that the customer flow is presented in graphical form. FIG. 34 is a view showing the amount of withdrawals and the amount of new enrollments by group (rank) in connection with all customers of the shop. FIG. 35 is a view illustrating a balance between the increase and decrease in the number of customers by group. FIG. 36 is a view illustrating the amount of withdrawals and the amount of new enrollments and the amounts of rise and fall in rank by rank in connection with all customers of the shop. The main office terminal 12 and the shop terminal 33 execute an application supplied from the web server 23a or a program stored by each terminal based on information stored by each terminal or the POS data storage 11, thereby creating data indicative of images shown in FIGS. 30 to 36 based on data stored by the main office terminal 12 and the shop terminal 33 or the POS data storage 11 to display these images. Additionally, regarding the element that satisfies a predetermined condition, the main office terminal 12 and the shop terminal 33 may display the pertinent portion in a different manner from the other element value at the time of displaying each of the screens of FIGS. 30 to 36.

The main office terminal 12 and the shop terminal 33 may execute the aforementioned processing relating to the customer flow analysis according to any conditions, for example, area, shop, salesperson, commodity, physique, and the like without limiting to the customer rank. Additionally, the main office terminal 12 and the shop terminal 33 may display the customer trace analytical screen in a state that each of the screens of FIGS. 30 to 36 is displayed in response to the operation from the operator. This makes it easy to carry out such a task of setting up a hypothesis on the customer purchase pattern and a task of verifying the hypothesis based on the action history.

The main office terminal 12 and the shop terminal 33 visualizes the result of the customer flow analysis in the form of the table and graph, making it easy for the client company to grasp a customer's complicated purchase action.

For example, referring to the screens of FIGS. 34 to 36, it is shown that the higher the customer rank, the lower the withdrawal rate, meanwhile the number of new enrollments becomes small and the distribution of the withdrawal rate and that of the new enrollment rate by rank form a pyramidal shape. Moreover, it is shown that the existing customers, who conventionally belonged to the lower rank, is ranked up and join in the higher rank in many cases. It is also shown that and the customers withdraw due to the rank-down in many cases.

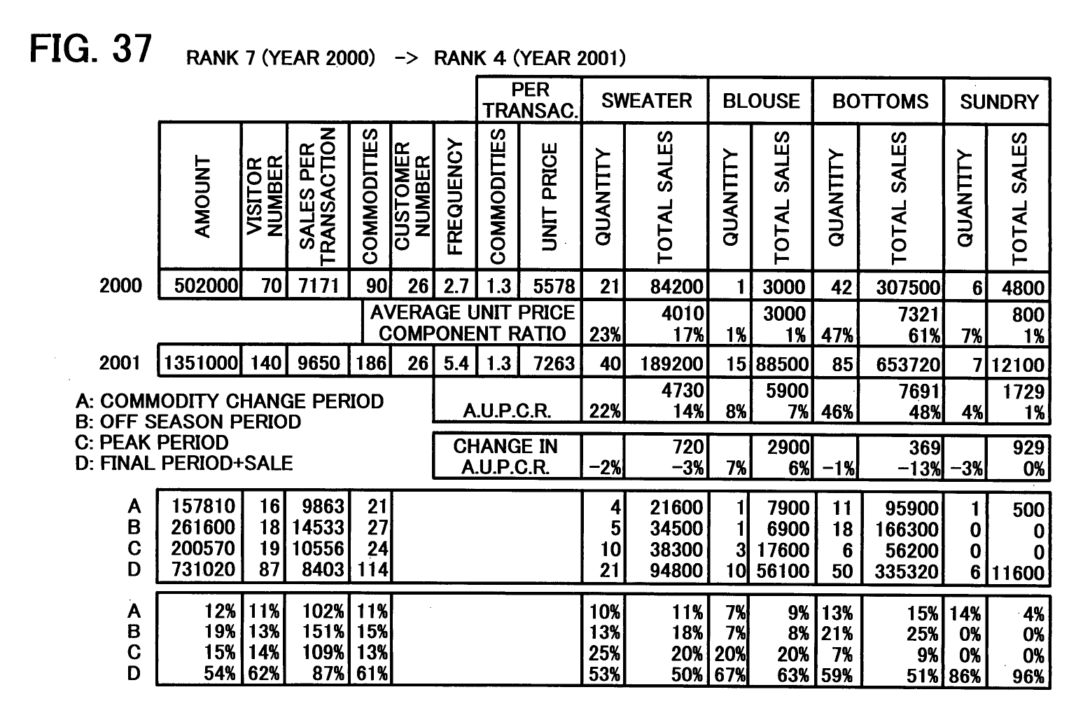

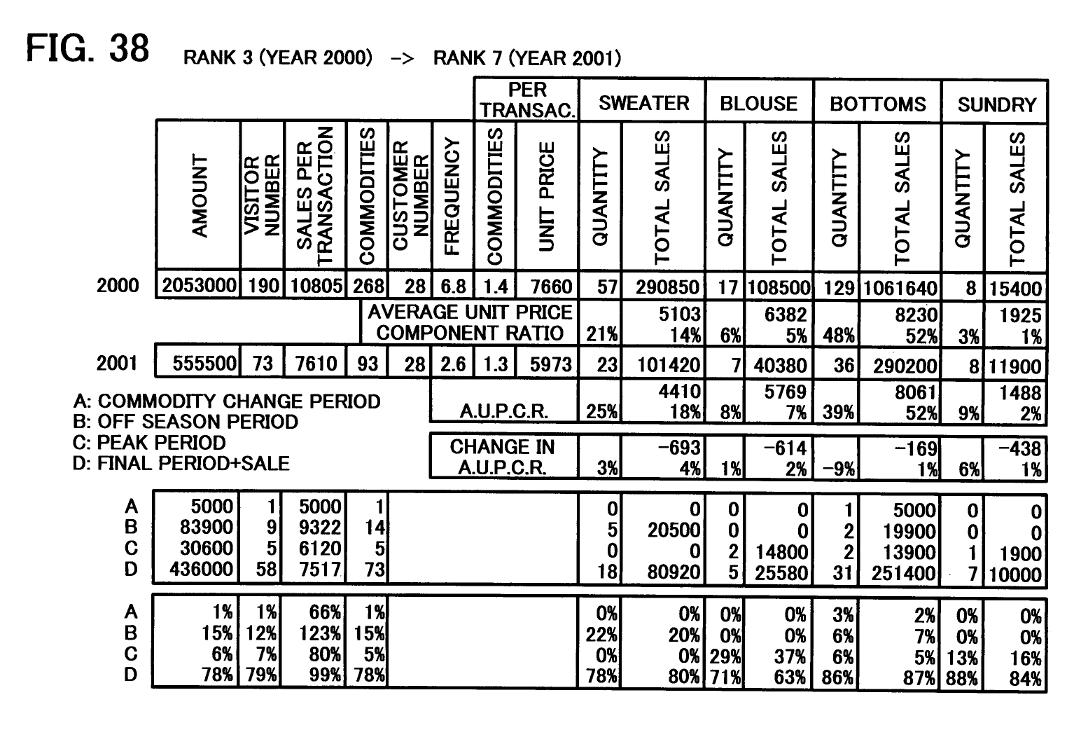

Furthermore, the main office terminal 12 and the shop terminal 33 display a screen, which shows the contents of the business transaction conducted between the customer, who belongs to the pertinent element, and the client company according to the operation from the operation in connection with each element of the aforementioned matrix. The client company can perform comparison in the customer trend between the multiple elements by displaying the pertinent screens of the multiple elements simultaneously. FIGS. 37 and 38 are views each illustrating an example of the pertinent screen. FIG. 37 is a view showing the contents of the business transaction conducted by the customer whose rank was moved up to 4 from 7 during 2000 to 2001. FIG. 38 is a view showing the contents of the business transaction conducted by the customer whose rank was moved down to 7 from 3 during 2000 to 2001.

Referring to the screens of FIGS. 37 and 38, it is shown that weight, which is placed on a specific commodity among commodities to be purchased, is reduced in the case of the customer whose rank was moved down to, for example, 7 from 3. It is also shown that such the customer purchases the commodity at only the time of a specific sale. On the other hand, it is shown that the commodity to be mainly purchased is shifted to blouses from bottoms in the case of the customer whose rank was moved up to 4 from 7. Moreover, it is shown that a sales rate is increased at a commodity change period and an off season time. Then, the client company may plan a strategy such as “Recommend the customer, whose rank was moved up, blouses at a commodity change period and an off season time” or “Enhance invitation measures excepting sales time” based on such understanding and execute the strategy. In addition, regarding the element that satisfies a predetermined condition, the main office terminal 12 and the shop terminal 33 may display the pertinent portion in a different manner from the other element value at the time of displaying each of the screens of FIGS. 37 and 38.

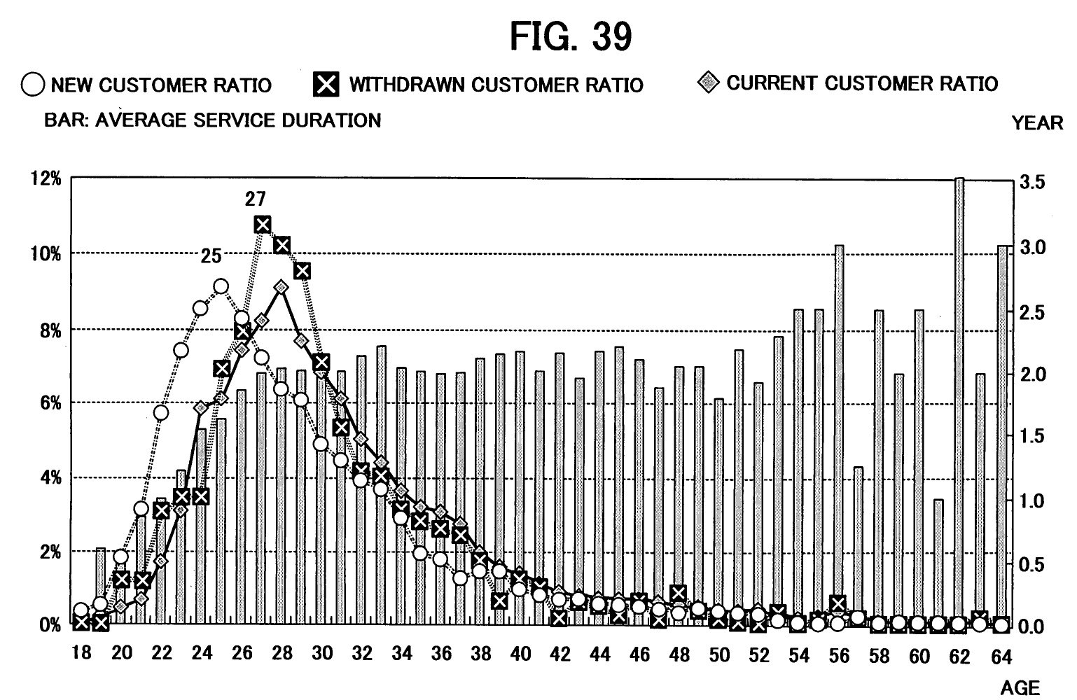

FIGS. 39 to 41 are views each illustrating an example of a customer life time analysis. The main office terminal 12 and the shop terminal 33 execute an application supplied from the web server 23a or a program stored by each terminal based on information stored by each terminal or the POS data storage 11, thereby creating data indicative of images shown in FIGS. 39 to 41 based on data stored by the main office terminal 12 and the shop terminal 33 or the POS data storage 11 to display these images.

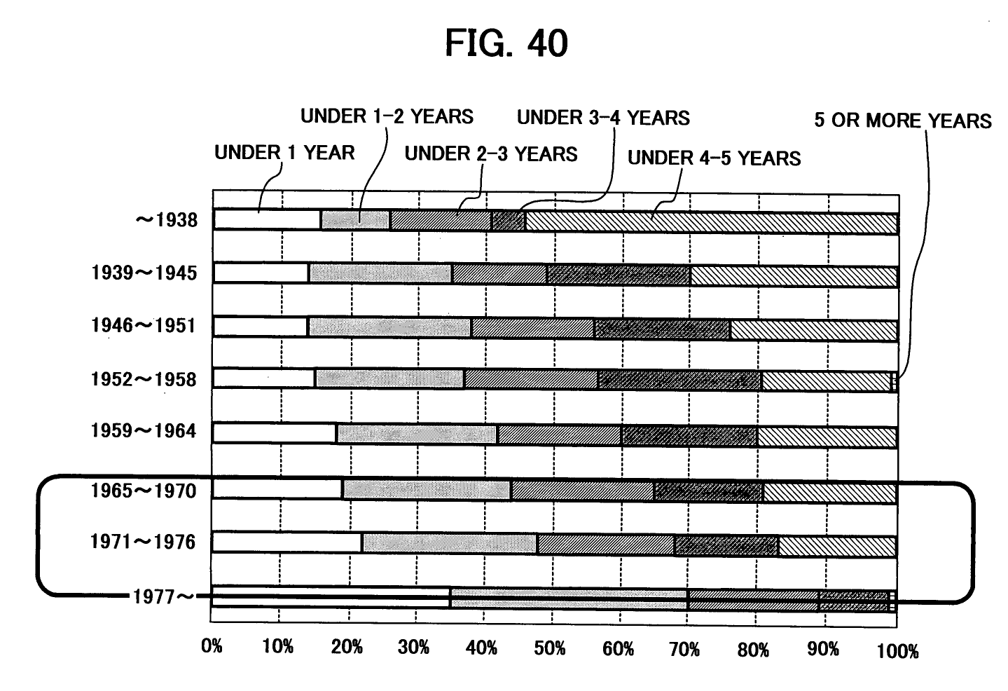

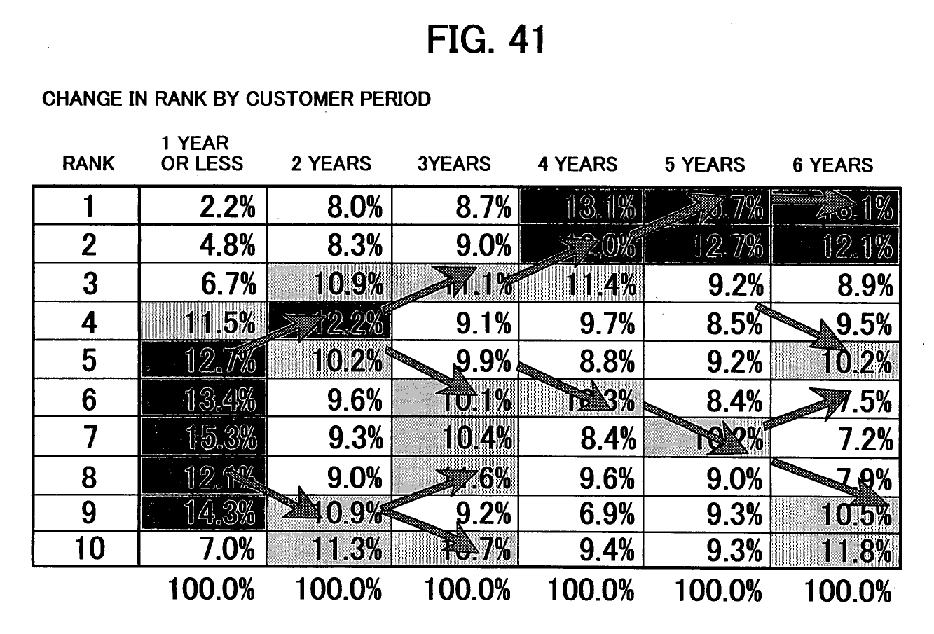

FIG. 39 is a view showing an age-specific percentage of current customers, age-specific percentages in connection with customers' ages at an enrolling time and a withdrawing time, and average service duration by age of current member. FIG. 40 is a view illustrating average service duration by generation. FIG. 41 is a view illustrating that a rate of customers belonging to each rank is shown by service duration. Referring to FIG. 39, it is shown that the average age of the current customers is about 29 and the main ages are 25 to 31. It is also shown that the mode value of customers' ages at an enrolling time is 25, and the mode value of customers' ages at a withdrawing time is 27 and the average is about 30. Moreover, referring to FIG. 40, it is shown that the service duration of current customers is approximately 2 years. It is also shown that correlation between the service duration of customers and the age is not so strong. It can be consider that the the client company plans strategies such as “Encourage the customers with about ages 18 to 23 to enroll in order to reduce the average age of customers in view of the fact that the shop handles accessories” and “Aim at encouraging the customers of the shops in Japan to continue to receive service over 5 years in average in view of the fact that female college graduates work for 5.4 years in average and female high school graduates work for 7.3 years in average” based on such understanding and executes the strategies.

Furthermore, referring to FIG. 41, for example, it is shown that the customers, who newly enroll, start from the lower rank in many cases and are divided into the higher rank and the lower rank with the passage of time. It is also shown that there is a possibility that the customers, who moved up to the upper rank, will move up to a much upper rank and the customers, who moved down to the lower rank, will move down to a much lower rank with the passage of service duration. It can be considered that the memory of the commodity purchase is imprinted in the customer's mind for a long time to exert an influence on the customer's purchase action, thereby causing the aforementioned trends. It can be considered that the client company plans strategies such as “Continue to execute an action for enhancing the relationship to the customers in the second year and more years after the enrollment in order to fix the memory of business transaction” based on such understanding and executes the strategy.

An explanation will next given of processing for narrowing down a customer to be subjected to outbound as processing that belongs to the relationship process system.

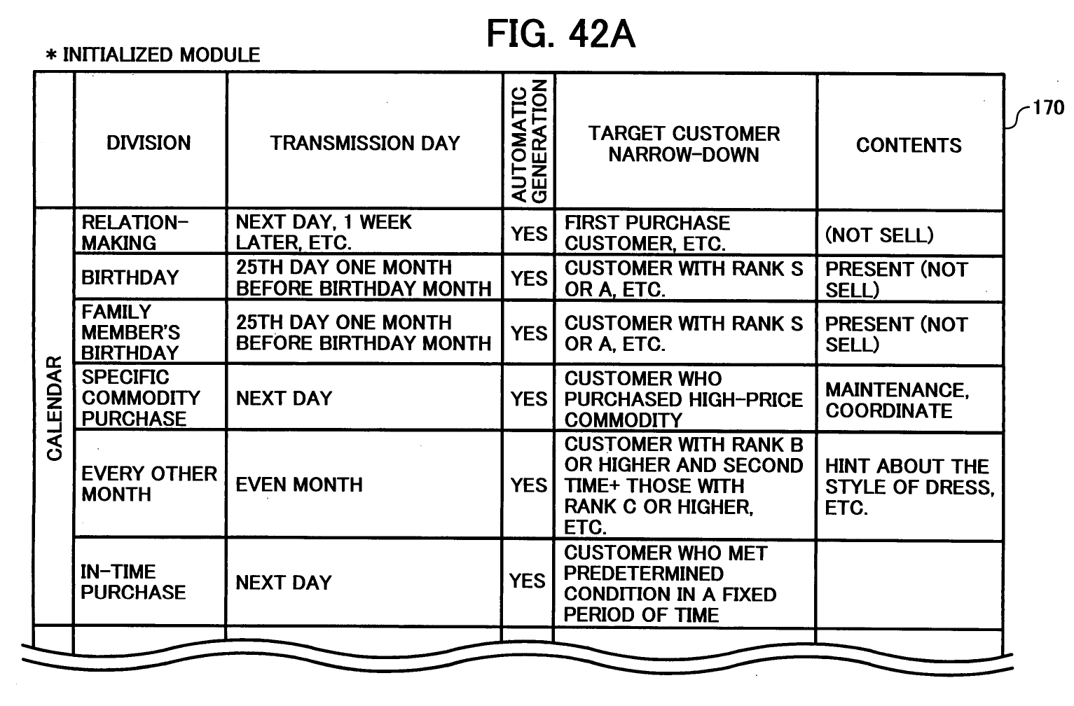

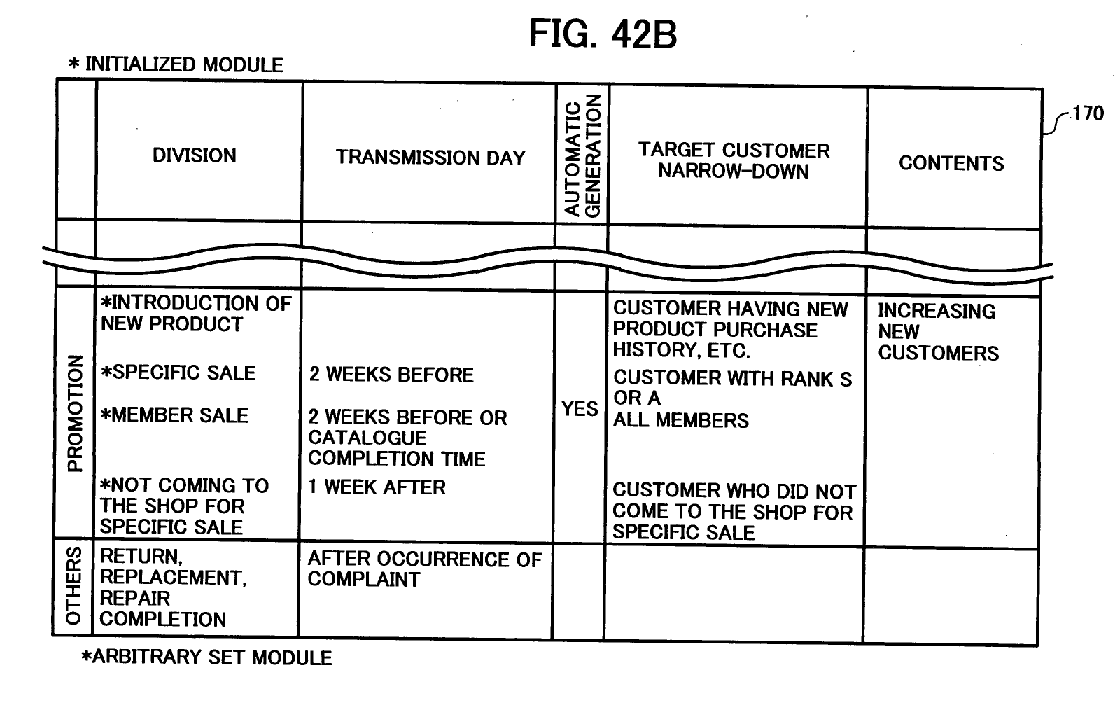

In order to perform processing for narrowing down a customer, for example, the main office terminal 12 and the shop terminal 33 displays a screen shown in FIGS. 42A and 42B to provide GUI to an operator, encouraging the operator to input a customer narrow-down condition. This screen also includes an initialization module 170, which is a screen that is used when the operator sets an outbound transmission. As illustrated in the figure, the initialization module 170includes a column for entering a promotion division, a column for entering a transmission date of an outbound relating to the promotion of the pertinent division, a column for entering a narrow-down condition of a customer to be subjected to the pertinent outbound, and a column for entering the contents of the pertinent outbound.

The main office terminal 12 and the shop terminal 33, which displayed the screen of FIGS. 42A and 42B, search customer information, which the POS data storage 11 stores, according to the narrow-down condition input in such a way that the operator enters a character string to the initialization module 170. The narrow-down condition can be described using a rule set by use of, for example, the aforementioned rule setting screen. Then, the main office terminal 12 and the shop terminal 33 execute an outbound to the customer shown by the searched information or support the pertinent outbound. More specifically, on the transmission date entered to the initialization module 170, the main office terminal 12 and the shop terminal 33 create e-mail having the contents associated with the pertinent transmission date, and send the e-mail to the customer associated with the pertinent transmission date. For example, the contents of e-mail may be prestored by the main office terminal 12, the shop terminal 33 or the POS data storage 11. Or, the main office terminal 12 and the shop terminal 33 may detect the arrival of the pertinent transmission date to output an alarm (for example, display that encourages the transmission of e-mail) in order to support the outbound. Moreover, the main office terminal 12 and the shop terminal 33 may cause the printer 23b to print DM having the contents associated with the pertinent transmission date on the pertinent transmission date.

In addition, regarding the outbound belonging to the division of “relation-making”, FIGS. 42A and 42B illustrate a case in which the following setting is performed. Namely, target customers are those who made a first purchase, (up to a next purchase), and those who have a purchase amount of money or a purchase commodity history that conforms to a condition urgently designated by an operator, and the outbound with the contents including no text in which a commodity is sold is performed to such customers on the next day when the customer came to the shop at the first time, in one week later, 20 days later, one month later, three months later, and six months later.

Moreover, regarding the outbound belonging to the division of “customer's birthday” and “his/her family member's birthday”, FIGS. 42A and 42B illustrate a case in which the following setting is performed. Namely, target customers are those who belong to specific upper ranks (for example, rank S and rank A on the assumption that the customer rank is set to “S” as a highest rank, and “A”, “B”, “C”, “D”, and “E” in order ), those who are urgently designated by an operator, and family members of these customers, and the outbound with the contents including no text in which a commodity is sold is performed to such customers on 25th day one month before the customer's birthday month, and the shop terminal 33 outputs an alarm instructing the salesperson of the shop 30 to give a present to these customers and their family members when they come to the shop 30.

Furthermore, regarding the outbound belonging to the division of “specific commodity purchase”, FIGS. 42A and 42B illustrate a case in which the following setting is performed. Namely, an outbound with the contents including a text in which advice on commodity maintenance, coordinate, and the like is given is performed to customers who purchased a high-price commodity whose price is a predetermined value two times or more.

Still furthermore, regarding the outbound belonging to the division of “every other month”, FIGS. 42A and 42B illustrate a case in which the following setting is performed. Namely, customers are those who belong to rank B or higher and are subjected to the pertinent outbound two times or more, and those who belong to rank C or higher and are subjected to the pertinent outbound three times or more, and the outbound with the contents including a text in which a hint about the style of dress appealing the sense of season is described is performed to such customers on an even month.

Still moreover, regarding the outbound belonging to the division of “in-time purchase”, FIGS. 42A and 42B illustrate a case in which the following setting is performed. Namely, customers are those, who have a have sales amount and a sales frequency that are reached a predetermined value in a fixed period of time, and the outbound is performed to such customers on a next day after a purchase. Additionally, in this case, the fixed period of time, the predetermined value of the sales amount and the sales frequency may be prestored by the main office terminal 12, the shop terminal 33, or the POS data storage 11 according to a designation from an operator.

Still moreover, regarding the outbound belonging to the division of “introduction of new product”, FIGS. 42A and 42B illustrate a case in which the following setting is performed. Namely, customers are those who purchased a new product in the past and those who are designated by an operator, and the outbound is performed to such customers prior to the introduction of a new product. Additionally, in this case, regarding how many days prior to the introduction of a new product the outbound is performed, they may be prestored by the main office terminal 12, the shop terminal 33, or the POS data storage 11 according to a designation from an operator.

Still furthermore, regarding the outbound belonging to the division of “specific sale”, FIGS. 42A and 42B illustrate a case in which the following setting is performed. Namely, an outbound is performed to customers, who belong to rank A or higher, two weeks before a specific sale. While, regarding the outbound belonging to the division of “member sale”, FIGS. 42A and 42B illustrate a case in which the following setting is performed. Namely, an outbound is performed to all customers two weeks before a member sale.

Still moreover, regarding the outbound belonging to the division of “not coming to shop for specific sale”, FIGS. 42A and 42B illustrate a case in which the following setting is performed. Namely, customers are those who target persons for a specific sale (specifically, customers who belong to rank A or higher) and customers, who did not come to the shop for the specific sale, and the outbound is performed to such customers one week later after the specific sale. Additionally, in this case, the main office terminal 12, the shop terminal 33 may prestore information, which specifies the customer who came to the shop for the specific sale, according to an operation from an operator and search a customer, who did not come to the shop for the specific sale, based on the pertinent information. Or, the main office terminal 12, the shop terminal 33 may obtain customer information read from the member card of the customer, who came to the shop for the specific sale, by the card reader 31, and generate information, which specifies a customer who comes to the shop for the specific sale, based on the pertinent information, and store it.

Still furthermore, FIGS. 42A and 42B illustrate a case in which such a setting is performed where an outbound with the contents including apology is executed to a client, who made a complaint, after occurrence of the pertinent complaint.

The aforementioned outbound setting is no more than one example, and the main office terminal 12 and the shop terminal 33 may associate the outbound setting with another arbitrary condition.

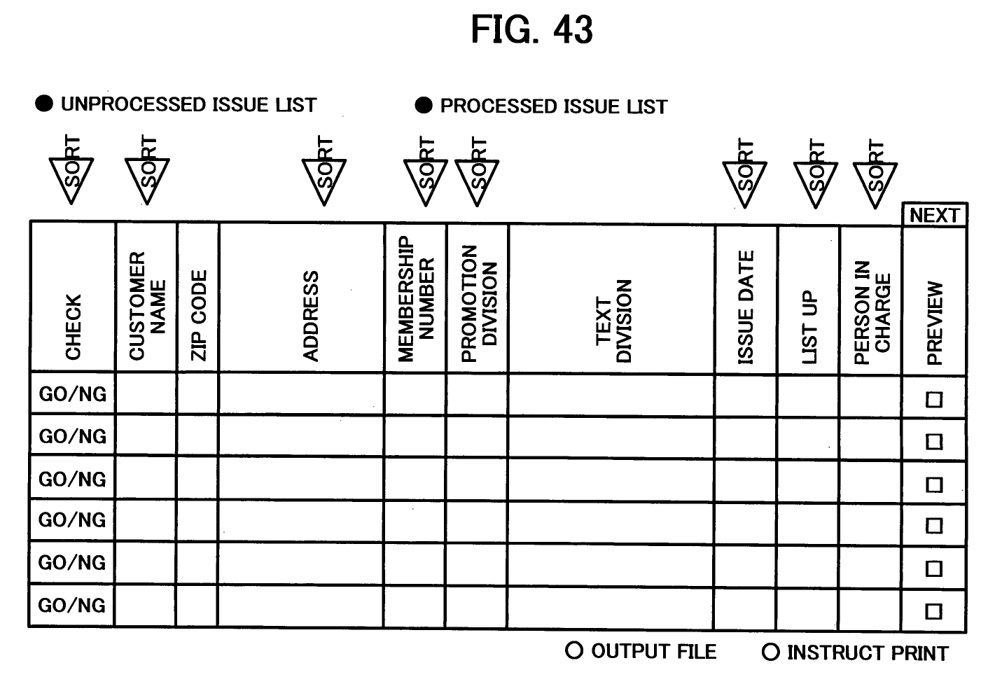

Moreover, the main office terminal 12 and the shop terminal 33 display, for example, a DM transmission selection screen shown in FIG. 43 according to an operation from an operator (for example, merger of the main office 10 and the shop 30) to which predetermined authentication information is allocated and provide GUI to the operator. The operator can use the DM transmission selection screen for a task that confirms the contents of DM and a task that approves the transmission of DM.

The DM transmission selection screen includes an unprocessed list, which lists and displays information relating to an untransmitted DM, and a processed list, which lists and displays information relating to a transmitted DM, and the main office terminal 12 and the shop terminal 33 display at least one of the unprocessed list and the processed list according to an instruction from an operator.

As illustrated in the figure, the unprocessed list includes, for example, a check column for confirming the transmission of the pertinent DM every one DM, a name of a customer as a destination of the pertinent DM, an address, a membership number, an outbound division, a text showing a script of the pertinent DM, a nearest issue date when the pertinent DM is transmitted to the pertinent customer, a date when the pertinent customer is listed, a name of a person in charge who made a list, and a preview input column. It is assumed that the operators of the main office terminal 12 and the shop terminal 33 input these information items in advance, or extracts information relating to a customer left resulting from the aforementioned processing for narrowing down a customer to be subjected to the outbound, or the card reader 31 reads these information items from the membership card, and the main office terminal 12, the shop terminal 33, and POS data storage 11 store them. Moreover, it is assumed that correction and addition can be added to the text showing a script of the pertinent DM among these information items in the unprocessed list. Furthermore, when the operator performs such an entry that selects “GO” from “GO” and “NG” described in the DM check column to confirm the transmission of DM, the main office terminal 12 and the shop terminal 33 display a screen that encouraging, for example, the confirmation of the number of printed DMs and the contents in response to the entry.

On the other hand, the processed list may include the items excepting the check column from the aforementioned unprocessed list.

Moreover, when multiple same addresses and membership numbers are displayed in the DM transmission selection screen, the main office terminal 12 and the shop terminal 33 may display the pertinent address or membership number in a different manner such as inverse display and the like unlike the normal manner. Furthermore, information on a customer who is in a state that the nearest issue date of DM is within a predetermined period of time (for example, one month) from the current date may be displayed in a different manner from the normal manner.

Moreover, the main office terminal 12 and the shop terminal 33 may cause the printer 23b to print the DM transmission selection screen and may generate an image file indicating the DM transmission selection screen.

Furthermore, the main office terminal 12 and the shop terminal 33 may display a screen having the same configuration as the DM transmission selection screen in order to support a task that confirms the contents of e-mail and facsimile to be transmitted to the customer and a task that approves the transmission without limiting the screen to the aforementioned DM transmission selection screen. Similar to the screen as shown in FIG. 43, this screen may include, for example, a check column for confirming the transmission of the pertinent e-mail or facsimile every one e-mail or facsimile, a name of a customer as a destination of the pertinent e-mail or facsimile, an address, a membership number, an outbound division, a text showing a text of the pertinent e-mail or a script of the pertinent facsimile, a nearest issue date when the pertinent e-mail or facsimile is transmitted to the pertinent customer, a date when the pertinent customer is listed, a name of a person in charge who made a list, and a preview input column.

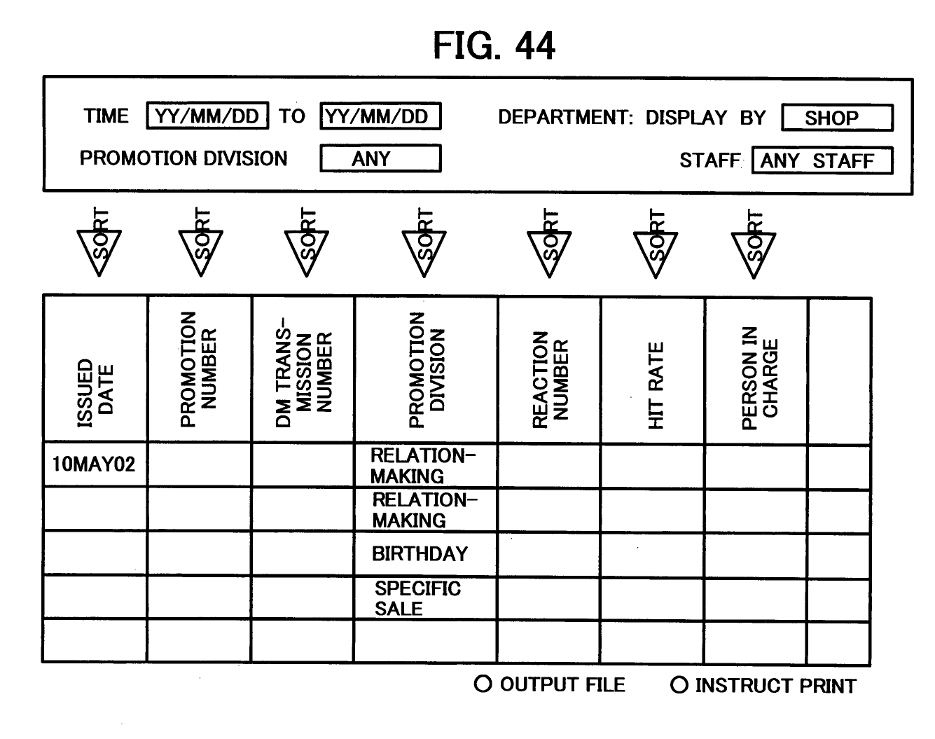

Moreover, the main office terminal 12 and the shop terminal 33 display, for example, a promotion analytical screen shown in FIG. 44 according to an operation from an operator. As illustrated in the figure, the promotion analytical screen includes, for example, an issue date of DM, e-mail, or facsimile due to the pertinent promotion every one promotion, a mark (for example, serial numbers) that identifies the pertinent promotion, the number of issued DMs, e-mails, or facsimiles, an outbound division relating to the pertinent promotion, the number of customers who shows some reaction to the outbound, and a rate (bit rate), and a name of person in charge who executes the pertinent promotion. For example, it is assumed that the operators of the main office terminal 12 and the shop terminal 33 input these information items in advance, or extracts these information items from data indicating the DM transmission selection screen, and the main office terminal 12, the shop terminal 33, and POS data storage 11 store them.

In addition, the main office terminal 12 and the shop terminal 33 may limit a promotion, which should display various kinds of data in the promotion analytical screen, to one that satisfies a condition designated by the operator. Any condition may be possible if the condition depends on, for example, time, an outbound division, a shop where a business transaction was made, a sales floor where a business transaction was made, an area where a business transaction was made, or a salesperson who was concerned with a business transaction.

As mentioned above, this one-to-one business support system can be provided at low cost as a whole product unlike the existing processing by CRM package, RMF analysis, decile analysis, data manning and the like.

According to the one-to-one business support system, there is provided a system that analyzes sales information and custom information to enable to issue a relationship tool to each customer consistently. Namely, the one-to-one business support system stores purchase information and customer information from the shop terminal, analyzes these stored information items, automatically generates an action plan for each customer according to a rule having a preset condition and the action contents, and issues a tool according to the action plan. Then, when the action is executed, the one-to-one business support system can receive a feedback of the result.

The one-to-one business support system collects the contents of speech uttered by the customer, information (attribute information) indicating a customer attribute and information indicating a purchase characteristic for each customer, and customizes itself using these. For example, when the customer makes a complaint and an inquiry to the shop, the main office of the client company and the headquarters receive the telephone and there is no direct contact with the shop in some cases. In such a case, the one-to-one business support system can offer information on the complaint and the inquiry to the shop terminal.

Moreover, for example, when information indicating the contents of the complaint and the inquiry is input to the main office terminal 12, the main office terminal 12 instructs the shop terminal 33 to display an icon showing a complaint and an inquiry. When the operator of the shop terminal 33 clicks the icon, the shop terminal 33 may obtain indicating the contents of the complaint and the inquiry from the main office terminal 12 in response to this click and display it. In this way, the one-to-one business support system may capture information indicating words uttered by the customer and make use of the action for each customer.

Furthermore, the one-to-one business support system can provide an issue of the relation tool such as DM via web service, and issue DM in which a script is personalized for each customer using an on-demand printing (ODP). Regarding ODP, a print output instruction can be provided from either one of the main office terminal 12 and the shop terminal 33.

Moreover, the main office of the one-to-one business support system predicts the next time when each customer will come to the shop using customer's purchase frequency data and sets a calendar to a predetermined time based on the predicted next time, enabling to execute a one-to-one action using a predetermined tool on the set day. For example, the main office can transmit DM, which is personalized for the pertinent custom, 10 days before the predicted day when each customer will come to the shop.

Furthermore, the one-to-one business support system uses a customer segmentation that is useful for a customer target to perform a customer flow analysis, and outputs information indicating a result. More specifically, for example, the one-to-one business support system obtains customer's purchase information and segments the customer based on decile, quintile, customer rank, or arbitrary reference value. This processing is performed multiple times at the multiple points in time to conduct the flow analysis using the result of these segmentations and output a result of flow analysis. However, the segmentation of the customer each time is performed using the same criterion in connection with at least the predetermined item (for example, annual purchase amount range). As a result, analyses on customer's rank movement between the previous time and this time, acquisition of new customers, withdrawal of customers, and the like are executed by the one-to-one business support system. Moreover, it is possible to confirm the purchase pattern of new customer group under a fixed condition.

Furthermore, the one-to-one business support system can display data of the number of customers in connection with the customers each having a fixed attribute, a purchase frequency, an event division, a classification of the purchased commodity, a unit price per one customer, the number of commodities per one customer, a unit price of commodity, and the like as a customer trace analytical report every month. The attributes of customers include the number of times on the cumulative purchases, a purchase frequency for a fixed time, a point per one customer, a unit price per one, the number of days passed since the final purchase date, a current customer rank, a customer rank at a past designated point in time, and the like. By such the customer trace analytical report, it is possible to confirm a time series change in the purchase pattern of the customer group extracted under the fixed condition. The user of the one-to-one business support system can extract the customer to be subjected to an actual action plan based on the purchase pattern.

The above explained the embodiment of the present invention. However, the one-to-one business support system according to the present invention can be implemented using a general computer system instead of a dedicated system.

From a storage medium (CD-ROM, MO, and the like), which stores a program for executing the operations of the aforementioned POS data storage 11, main office terminal 12, AP server 21a, web server 23a, POS register 32, and shop terminal 33, the program is installed on multiple computers connected to one another via a network where at least any one of computers is accessible to a card reader and a printer, thereby enabling to configure a multi function device that executes the aforementioned processing.

Moreover, for example, this program is uploaded on a bulletin board system (BBS) of a communication line, so that the program may be distributed via the communication line. Furthermore, a carrier wave is modulated by a signal indicating this program, the obtained modulated wave is transmitted, and an apparatus, which received this modulated wave, may demodulate the modulated wave to restore the program.

Then, the program is started to be executed under control OS similar to another application program, thereby enabling to execute the aforementioned processing.

Additionally, in the case where OS shares a part of processing, or OS configures a part of one configuration component of the present invention, a program excepting the corresponding portion may be stored on a storage medium. In this case, according to the present invention, it is assumed that a program for executing the respective functions and steps, which are executed by the computer, is stored on the storage medium.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2002-273197 filed on Sep. 19, 2002, Japanese Patent Application No. 2002-338941 filed on Nov. 22, 2002 and Japanese Patent Application No. 2003-320815 filed on Sep. 12, 2003 and including specification, claims, drawings and summary. The disclosures of the above Japanese Patent Applications are incorporated herein by reference in its entirety.

What is claimed is:

1. A one-to-one business support system comprising:
a storage device that stores customer attribute information indicating an attribute of a customer and purchase information indicating a commodity purchased by the customer;
a client computer that executes an application program to perform a first function of narrowing down a customer who satisfies a predetermined condition based on the customer information stored in said storage device, a second function of deciding a plan of an action that is performed to the customer narrowed down for each customer, a third function of issuing a relation tool for executing the decided plan, and/or a fourth function of performing an evaluation of the action according to a predetermined criterion; and
a server that provides the application program to said client computer.

2. The one-to-one business support system according to claim 1, wherein the application program provided by said server includes a program that causes said client computer to execute a fifth function of creating a script that defines the contents of the relation tool in a personalized form for each customer, and a sixth function of issuing the relation tool by instructing said server to output the relation tool having the contents according to the script, wherein said server includes an output device that outputs the relation tool according to the instruction of said client computer.

3. The one-to-one business support system according to claim 2, wherein said server includes a printer that prints the relation tool having the personalized contents for each customer according to an instruction of printing supplied from said client computer.

4. The one-to-one business support system according to claim 2, wherein said client computer includes a main office terminal and a shop terminal, and said main office terminal includes an output device that presents at least a part of information used in executing the first to fourth functions to an operator in a recognizable form, and said shop terminal includes an output device that presents at least a part of information used in executing the fifth and sixth functions to an operator in a recognizable form.

5. The one-to-one business support system according to claim 4, wherein the output device of said shop terminal obtains and/or stores customer attribute information of a customer, information indicating a rank when the customer is ranked on a predetermined criterion, information indicating a commodity purchased by the customer in the past and information indicating a history of a relation with the customer, and outputs any one of these information items that confirms to a condition designated by the operator.

6. The one-to-one business support system according to claim 1, wherein the action includes any one or more of an action of an event system that encourages the customer to come to the shop to improve sales promotion, an action of a calendar system that deepens the relationship with the customer to make the customer a regular customer to improve customer loyalization and an action of a shop service system that deepens the relationship with the customer at the shop to improve a sales rate or suggest coordinates.

7. The one-to-one business support system according to claim 6, wherein the action of the event system includes an action that issues a relation tool that transmits a message to the customer on a one-to-one basis, hereby sending a guide for a sales promotion to the customer, the action of he calendar system includes an action that issues a relation tool according to a calendar preset for each event, and the action of the shop service system includes an action that presents the contents of a personalized script to a person to be served.

8. The one-to-one business support system according to claim 1, wherein said client computer captures language information indicating words uttered by the customer and present the language information to an operator in a predetermined form that the operator can recognize.

9. The one-to-one business support system according to claim 1, wherein the relation tool includes at least any one of DM (Direct Mail), facsimile, e-mail, and telephone.

10. The one-to-one business support system according to claim 1, wherein the application program provided by said server includes a program that causes said client computer to perform a function of specifying a frequency of which the customer conducts a business transaction at the shop based on the customer attribute information to predict a day when the customer comes to the shop based on the frequency, and a function of detecting an arrival of a predetermined time decided based on the predicted day to perform an output of a message that encourages execution of the action and/or an issue of an relation tool relating to the action.

11. The one-to-one business support system according to claim 1, wherein the application program provided by said server includes a program that causes said client computer to perform a function of obtaining purchase information at multiple points in time in connection with persons, who are customers at at least any of the multiple points in time, to classify the respective customers at the multiple points in time into any of multiple ranks according to a predetermined criterion based on these purchase information and a function of specifying a variation in a customer rank, the number of newly enrolled customers and/or the number of withdrawn customers based on a result of the classification to output information indicating a specified result.

12. The one-to-one business support system according to claim 1, wherein the application program provided by said server includes a program that causes said client computer to perform a function of extracting a customer according to a predetermined condition based on the customer attribute information and/or purchase information and a function of generating data indicating at least any parameter of the number of extracted customers, a frequency of which the corresponding customer purchases a commodity, a type of a commodity purchased by the corresponding customer, a sales amount per one corresponding customer, the number of purchased commodities per one corresponding customer and a unit price of the commodity purchased by the corresponding customer and data indicating a time transition of the parameter value based on the customer attribute information and/or purchase information.

13. The one-to-one business support system according to claim 1, wherein said server provides the application program by executing an ASP (Application Service Provider) service.

14. The one-to-one business support system according to claim 1, further comprising a card reader that reads customer attribute information and/or purchase information from a magnetic card or an IC (Integrated Circuit) card to obtain the customer attribute information and/or purchase information or a POS (Point OF Sales) register that obtains customer attribute information and/or purchase information according to an operation from an operator, wherein said card reader and said POS register are connected to said storage device via a communication line, and the obtained customer attribute information and/or purchase information is supplied to said storage device and stored therein.

15. The one-to-one business support system according to claim 1, wherein said server includes a web server and the web server provides data to said client computer that functions as a client machine via a network according to a communication procedure where security is ensured.

16. The one-to-one business support system according to claim 15, further comprising a database server connected to said storage device via a communication line where security is ensured, wherein said database server and said application server are connected to each other via a firewall to form a security capsule zone.

17. A computer data signal embedded in a carrier wave that indicates a program for causing a computer to function as a storage device that stores customer attribute information indicating an attribute of a customer and purchase information indicating a commodity purchased by the customer, a client computer that executes an application program to perform a first function of narrowing down a customer who satisfies a predetermined condition based on the customer information stored in said storage device, a second function of deciding a plan of an action that is performed to the customer narrowed down for each customer, a third function of issuing a relation tool for executing the decided plan, and/or a fourth function of performing an evaluation of the action according to a predetermined criterion and a server that provides the application program to said client computer.

18. A computer-readable storage medium having a program recorded thereon, said program causing a computer to function as a storage device that stores customer attribute information indicating an attribute of a customer and purchase information indicating a commodity purchased by the customer, a client computer that executes an application program to perform a first function of narrowing down a customer who satisfies a predetermined condition based on the customer information stored in said storage device, a second function of deciding a plan of an action that is performed to the customer narrowed down for each customer, a third function of issuing a relation tool for executing the decided plan, and/or a fourth function of performing an evaluation of the action according to a predetermined criterion and a server that provides the application program to said client computer.
